(19) United States
(12) Patent Application Publication
(10) Pub. No.: US 2022/0244655 A1
(43) Pub. Date: Aug. 4, 2022

(54) TONER FOR ELECTROSTATIC IMAGE DEVELOPMENT

(71) Applicant: FUJIFILM Business Innovation Corp., Tokyo (JP)

(72) Inventors: Kana NAGASHIMA, Kanagawa (JP); Masaru TAKAHASHI, Kanagawa (JP); Yukiaki NAKAMURA, Kanagawa (JP); Ryutaro KEMBO, Kanagawa (JP); Tomoaki TANAKA, Kanagawa (JP)

(73) Assignee: FUJIFILM Business Innovation Corp., Tokyo (JP)

(21) Appl. No.: 17/491,614

(22) Filed: Oct. 1, 2021

(30) Foreign Application Priority Data
Jan. 29, 2021 (JP) 2021-013925

(51) Int. Cl. G03G 9/087; G03G 9/09

(52) U.S. Cl. CPC G03G 9/08755; G03G 9/0906; G03G 9/08782

(57) ABSTRACT

A toner for electrostatic image development includes toner particles containing a binder resin, a dye, and a release agent. When a cross section of the toner particles is observed, the percentage of the release agent present in regions whose distances from the surfaces of the toner particles are 400 nm or less is from 25% to 50% inclusive with respect to the total amount of the release agent.

### CROSS-REFERENCE TO RELATED APPLICATIONS

This application is based on and claims priority under 35 USC 119 from Japanese Patent Application No. 2021-013925 filed Jan. 29, 2021.

### BACKGROUND

### (i) Technical Field

The present disclosure relates to a toner for electrostatic image development.

### (ii) Related Art

Japanese Unexamined Patent Application Publication No. 2005-227671 proposes “a toner for electrophotography including a core layer containing at least a crystalline resin and a coloring agent, a wax layer containing a release agent and covering the core layer, and a shell layer containing an amorphous resin and covering the wax layer.”

### SUMMARY

Aspects of non-limiting embodiments of the present disclosure relate to a toner for electrostatic image development including toner particles containing a binder resin, a dye, and a release agent. With this toner for electrostatic image development, the difference in gloss that occurs when images are formed continuously is smaller than that when the percentage of the release agent present in regions whose distances from the surfaces of the particles are 400 nm or less is less than 25% or more than 50% with respect to the total amount of the release agent when a cross section of the toner particles is observed, when the ratio of the percentage of the release agent on the surfaces of the toner particles as measured by X-ray photoelectron spectroscopy to the percentage of the binder resin on the surfaces of the toner particles as measured by X-ray photoelectron spectroscopy is less than 10%, when the percentage of the release agent present in regions whose distances from the surfaces of the toner particles are 2 μm or more is more than 1% with respect to the total amount of the binder resin when a cross section of the toner particles is observed, or when 1.5>W1/W2 or 4<W2/W3 is satisfied when a cross section of the toner particles is observed, where W1 is the area of the release agent present in regions whose distances from the surfaces of the toner particles are less than 1 μm, W2 is the area of the release agent present in regions whose distances from the surfaces of the toner particles are 1 μm or more and less than 2 μm, and W3 is the area of the release agent present in regions whose distances from the surfaces of the toner particles are 2 μm or more.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a toner for electrostatic image development including: toner particles containing a binder resin, a dye, and a release agent,

wherein, when a cross section of the toner particles is observed, the percentage of the release agent present in regions whose distances from the surfaces of the toner particles are 400 nm or less is from 25% to 50% inclusive with respect to the total amount of the release agent.

### BRIEF DESCRIPTION OF THE DRAWINGS

Exemplary embodiments of the present disclosure will be described in detail based on the following figures, wherein:

FIG. 1 is a schematic configuration diagram showing an example of an image forming apparatus according to an exemplary embodiment; and

FIG. 2 is a schematic configuration diagram showing an example of a process cartridge according to an exemplary embodiment.

### DETAILED DESCRIPTION

Exemplary embodiments of the present disclosure will be described below. The following description and Examples are illustrative of the present disclosure and are not intended to limit the scope of the present disclosure.

In a set of numerical ranges expressed in a stepwise manner in the present specification, the upper or lower limit in one numerical range may be replaced with the upper or lower limit in another numerical range in the set of numerical ranges expressed in a stepwise manner. Moreover, in a numerical range described in the present specification, the upper or lower limit in the numerical range may be replaced with a value indicated in an Example.

Any component may contain a plurality of materials corresponding to the component.

When reference is made to the amount of a component in a composition, if the composition contains a plurality of materials corresponding to the component, the amount means the total amount of the plurality of materials in the composition, unless otherwise specified.

### <Toner for Electrostatic Image Development>

A toner for electrostatic image development according to a first exemplary embodiment (“the toner for electrostatic image development” may be hereinafter referred to simply as “the toner”) includes toner particles containing a binder resin, a dye, and a release agent.

When a cross section of the toner particles is observed, the percentage of the release agent present in regions whose distances from the surfaces of the toner particles are 400 nm or less is from 25% to 50% inclusive with respect to the total amount of the release agent.

A toner for electrostatic image development according to a second exemplary embodiment includes toner particles containing a binder resin, a dye, and a release agent.

The ratio of the percentage of the release agent on the surfaces of the toner particles as measured by X-ray photoelectron spectroscopy to the percentage of the binder resin on the surfaces of the toner particles as measured by X-ray photoelectron spectroscopy is 10% or more.

With the above-described toners according to the first and second exemplary embodiments, the difference in gloss that occurs when images are formed continuously is small. The reason for this may be as follows.

In recent years, an increase in the quality of images formed and an increase in the speed of image formation are required. To address these requirements, a toner including toner particles containing a binder resin and a release agent is used in some cases. However, when the dispersion state of the release agent in the toner is insufficient, defective fixation tends to occur when the toner is fixed onto a recording medium, so that the toner tends to adhere to a fixing member in some cases. The toner adhering to the fixing member is removed by a cleaning member. However, the release agent contained in the toner is not easily removed and is likely to remain on the fixing member. Therefore, in a portion of the fixing member in which the release agent remains present, the toner is unlikely to adhere to the fixing member during fixation when an image is again formed, so that an image with a smooth surface is obtained. However, in a portion of the fixing member in which no release agent remains present, the toner is likely to adhere to the fixing member. In this case, defective fixation is likely to occur, and a phenomenon in which part of the image is transferred to the fixing member (i.e., offset) is likely to occur. This is likely to cause a difference in gloss.

The difference in gloss is the difference in gloss between images.

The above phenomenon that occurs when a toner including toner particles containing a binder resin and a release agent is used is significant in some cases when the toner particles included in the toner used further contain a dye. The dye may form an ionic bond etc. with the binder resin. The binder resin and the dye combined through an ionic bond etc. are insolubilized in the toner particles, and the release agent is less likely to be present on the surfaces of the toner particles. Specifically, the release agent tends to be distributed mainly in central portions of the toner particles. Therefore, a sufficient amount of the release agent cannot be supplied to a fixing member during fixation of the toner, so that defective fixation is likely to occur. In this case, the toner tends to adhere to the fixing member. Therefore, when images are formed continuously, the difference in the gloss between the images may be likely to increase.

In the toner according to the first exemplary embodiment, when a cross section of the toner particles is observed, the percentage of the release agent present in regions whose distances from the surfaces of the toner particles are 400 nm or less is from 25% to 50% inclusive with respect to the total amount of the release agent. In the toner according to the second exemplary embodiment, the ratio of the percentage of the release agent on the surfaces of the toner particles as measured by X-ray photoelectron spectroscopy to the percentage of the binder resin on the surfaces of the toner particles as measured by X-ray photoelectron spectroscopy is 10% or more. Therefore, although the toner particles contain the dye, a certain amount of the release agent is present on the surfaces of the toner particles. Therefore, a sufficient amount of the release agent is likely to be supplied to the fixing member during fixation, and the toner is unlikely to adhere to the fixing member. Thus, although the toners according to the first and second exemplary embodiments each include the toner particles containing the binder resin, the dye, and the release agent, the difference in the gloss between images when the images are formed continuously is small.

It is therefore inferred that, with the toners according to the first and second exemplary embodiments, the difference in gloss that occurs when images are formed continuously is small because of the reason described above.

A toner according to a third exemplary embodiment includes toner particles containing a binder resin, a dye, and a release agent.

When a cross section of the toner particles is observed, the percentage of the release agent present in regions whose distances from the surfaces of the toner particles are 2 μm or more is 1% or less with respect to the total amount of the binder resin.

With the above-described toner according to the third exemplary embodiment, the difference in gloss that occurs when images are formed continuously is small. The reason for this may be as follows.

In the toner according to the third exemplary embodiment, when a cross section of the toner particles is observed, the percentage of the release agent present in the regions whose distances from the surfaces of the toner particles are 2 μm or more is 1% or less with respect to the total amount of the binder resin. Therefore, although the toner particles contain the dye, the percentage of the release agent present in central portions of the toner particles is small. Therefore, a certain amount of the release agent is present on the surface side of the toner particles. In this case, a sufficient amount of the release agent is likely to be supplied to the fixing member during fixation, and the toner is unlikely to adhere to the fixing member. Therefore, although the toner according to the third exemplary embodiment includes the toner particles containing the binder resin, the dye, and the release agent, the difference in the gloss between images when the images are formed continuously is small.

It is therefore inferred that, with the toner according to the third exemplary embodiment, the difference in gloss that occurs when images are formed continuously is small because of the reason described above.

A toner according to a fourth exemplary embodiment includes toner particles containing a binder resin, a dye, and a release agent.

When a cross section of the toner particles is observed, formula 1: 1.5≤W1/W2 and formula 2: 4≤W2/W3 are satisfied, where W1 is the area of the release agent present in regions whose distances from the surfaces of the toner particles are less than 1 μm, W2 is the area of the release agent present in regions whose distances from the surfaces of the toner particles are 1 μm or more and less than 2 μm, and W3 is the area of the release agent present in regions whose distances from the surfaces of the toner particles are 2 μm or more.

With the above-described toner according to the fourth exemplary embodiment, the difference in gloss that occurs when images are formed continuously is small. The reason for this may be as follows.

In the toner according to the fourth exemplary embodiment, formula 1: 1.5≤W1/W2 and formula 2: 4≤W2/W3 are satisfied. When these requirements are met, the amount of the release agent present in the regions whose distances from the surfaces of the toner particles are less than 1 μm (surface layer portions) is the largest, and the amount of the release agent present in the regions whose distances from the surfaces of the toner particles are 1 μm or more and less than 2 μm (second layer portions) is the second largest. Moreover, the amount of the release agent present in the regions whose distances from the surfaces of the toner particles are 2 μm or more (central portions) is the smallest. Specifically, the percentage of the release agent present in the central portions of the toner particles is small, and a certain amount of the release agent is present on the surface side of the toner particles (the surface layer portions and the second layer portions). Therefore, a sufficient amount of the release agent is likely to be supplied to the fixing member during fixation, and the toner is unlikely to adhere to the fixing member. Thus, although the toner according to the fourth exemplary embodiment includes the toner particles containing the binder resin, the dye, and the release agent, the difference in the gloss between images when the images are formed continuously is small.

It is therefore inferred that, with the toner according to the fourth exemplary embodiment, the difference in gloss that occurs when images are formed continuously is small because of the reason described above.

A toner corresponding to all the toners according to the first to fourth exemplary embodiments (this toner is referred to also as “the toner according to the present exemplary embodiment”) will be described in detail. However, an example of the toner of the present disclosure may be a toner corresponding to any one of the toners according to the first to fourth exemplary embodiments.

### (Toner Particles)

Toner particles contain a binder resin including an amorphous resin and a crystalline resin, a dye, and a release agent.

### —Binder Resin—

Examples of the binder resin include: vinyl resins composed of homopolymers of monomers such as styrenes (such as styrene, p-chlorostyrene, and α-methylstyrene), (meth)acrylates (such as methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, and 2-ethylhexyl methacrylate), ethylenically unsaturated nitriles (such as acrylonitrile and methacrylonitrile), vinyl ethers (such as vinyl methyl ether and vinyl isobutyl ether), vinyl ketones (such as vinyl methyl ketone, vinyl ethyl ketone, and vinyl isopropenyl ketone), and olefins (such as ethylene, propylene, and butadiene); and vinyl resins composed of copolymers of combinations of two or more of the above monomers.

Other examples of the binder resin include: non-vinyl resins such as epoxy resins, polyester resins, polyurethane resins, polyamide resins, cellulose resins, polyether resins, and modified rosins; mixtures of the non-vinyl resins and the above-described vinyl resins; and graft polymers obtained by polymerizing a vinyl monomer in the presence of any of these resins.

One of these binder resins may be used alone, or two or more of them may be used in combination.

The binder resin may include the amorphous resin and the crystalline resin.

The amorphous resin exhibits only a stepwise endothermic change instead of a clear endothermic peak in thermal analysis measurement using differential scanning calorimetry (DSC), is a solid at room temperature, and is thermoplastic at temperature equal to or higher than its glass transition temperature.

The crystalline resin exhibits a clear endothermic peak instead of a stepwise endothermic change in the differential scanning calorimetry (DSC).

Specifically, the crystalline resin means that, for example, the half width of the endothermic peak measured at a heating rate of 10° C./minute is 10° C. or less, and the amorphous resin means a resin in which the half width exceeds 10° C. or a resin in which a clear endothermic peak is not observed.

The amorphous resin will be described.

Examples of the amorphous resin include well-known amorphous resins such as amorphous polyester resins, amorphous vinyl resins (such as styrene-acrylic resins), epoxy resins, polycarbonate resins, and polyurethane resins. Of these, amorphous polyester resins, and amorphous vinyl resins (particularly styrene-acrylic resins) resins are preferred, and amorphous polyester resins are more preferred.

Amorphous Polyester Resin

The amorphous polyester resin is, for example, a polycondensation product of a polycarboxylic acid and a polyhydric alcohol. The amorphous polyester resin used may be a commercial product or a synthesized product.

Examples of the polycarboxylic acid include aliphatic dicarboxylic acids (such as oxalic acid, malonic acid, maleic acid, fumaric acid, citraconic acid, itaconic acid, glutaconic acid, succinic acid, alkenyl succinic acids, adipic acid, and sebacic acid), alicyclic dicarboxylic acids (such as cyclohexanedicarboxylic acid), aromatic dicarboxylic acids (such as terephthalic acid, isophthalic acid, phthalic acid, and naphthalenedicarboxylic acid), anhydrides thereof, and lower alkyl (having, for example, 1 to 5 carbon atoms) esters thereof. In particular, the polycarboxylic acid may be, for example, an aromatic dicarboxylic acid.

The polycarboxylic acid used may be a combination of a dicarboxylic acid and a tricarboxylic or higher polycarboxylic acid having a crosslinked or branched structure. Examples of the tricarboxylic or higher polycarboxylic acid include trimellitic acid, pyromellitic acid, anhydrides thereof, and lower alkyl (having, for example, 1 to 5 carbon atoms) esters thereof.

One of these polycarboxylic acids may be used alone, or two or more of them may be used in combination.

Examples of the polyhydric alcohol include aliphatic diols (such as ethylene glycol, diethylene glycol, triethylene glycol, propylene glycol, butanediol, hexanediol, and neopentyl glycol), alicyclic diols (such as cyclohexanediol, cyclohexanedimethanol, and hydrogenated bisphenol A), and aromatic diols (such as an ethylene oxide adduct of bisphenol A and a propylene oxide adduct of bisphenol A). In particular, the polyhydric alcohol is, for example, preferably an aromatic diol or an alicyclic diol and more preferably an aromatic diol.

The polyhydric alcohol used may be a combination of a diol and a trihydric or higher polyhydric alcohol having a crosslinked or branched structure. Examples of the trihydric or higher polyhydric alcohol include glycerin, trimethylolpropane, and pentaerythritol.

One of these polyhydric alcohols may be used alone, or two or more of them may be used in combination.

The amorphous polyester resin is obtained by a well-known production method. Specifically, the amorphous polyester resin is obtained, for example, by the following method. The polymerization temperature is set to from 180° C. to 230° C. inclusive. If necessary, the pressure inside the reaction system is reduced, and the reaction is allowed to proceed while water and alcohol generated during condensation are removed.

When the raw material monomers are not dissolved or not compatible with each other at the reaction temperature, a high-boiling point solvent may be added as a solubilizer to dissolve the monomers. In this case, the polycondensation reaction is performed while the solubilizer is removed by evaporation. When a monomer with poor compatibility is present, the monomer with poor compatibility and an acid or an alcohol to be polycondensed with the monomer are condensed in advance, and then the resulting polycondensation product and the rest of the components are subjected to polycondensation.

Examples of the amorphous polyester resin other than the unmodified amorphous polyester resins described above include modified amorphous polyester resins. The modified amorphous polyester resin is an amorphous polyester resin including a bonding group other than the ester bonds or an amorphous polyester resin including a resin component that is different from the amorphous polyester resin component and is bonded through a covalent bond, an ionic bond, etc. Examples of the modified amorphous polyester resin include: an amorphous polyester resin in which a functional group such as an isocyanate group reactable with an acid group or a hydroxy group is introduced into an end of the resin; and a resin reacted with an active hydrogen compound to modify an end of the resin.

The modified amorphous polyester resin may be an amorphous polyester resin modified with urea (hereinafter referred to simply as a “urea-modified polyester resin”).

When the binder resin contains a urea-modified polyester resin as the amorphous polyester resin, the effect of improving releasability may be obtained by controlling the molecular weight distribution and viscoelasticity of the urea-modified polyester resin, so that the difference in gloss that occurs when images are formed continuously can be further reduced.

The urea-modified polyester resin may be obtained by the reaction of an amorphous polyester resin having isocyanate groups (amorphous polyester prepolymer) with an amine compound (at least one of a crosslinking reaction and an elongation reaction). The urea-modified polyester resin may have urethane bonds in addition to the urea bonds.

Examples of the amorphous polyester prepolymer having isocyanate groups include amorphous polyester resins that are polycondensation products of polycarboxylic acids and polyhydric alcohols, i.e., amorphous polyester prepolymers obtained by reacting amorphous polyester resins having active hydrogen with polyisocyanate compounds. Examples of the group having active hydrogen and included in the amorphous polyester resin include hydroxy groups (such as an alcoholic hydroxy group and a phenolic hydroxy group), an amino group, a carboxyl group, and a mercapto group, and the group having active hydrogen may by an alcoholic hydroxy group.

For the amorphous polyester prepolymer having isocyanate groups, the polycarboxylic acids and the polyhydric alcohols may be the same as the compounds explained as the polycarboxylic acids and the polyhydric alcohols for the amorphous polyester resin.

Examples of the polyisocyanate compound include: aliphatic polyisocyanates (such as tetramethylene diisocyanate, hexamethylene diisocyanate, and 2,6-diisocyanatomethyl caproate); alicyclic polyisocyanates (such as isophorone diisocyanate and cyclohexylmethane diisocyanate); aromatic diisocyanates (such as tolylene diisocyanate and diphenylmethane diisocyanate); aromatic aliphatic diisocyanates (such as α,α,α′,α′-tetramethylxylylene diisocyanate); isocyanurates; and compounds obtained by blocking the above polyisocyanates with blocking agents such as phenol derivatives, oximes, and caprolactam.

One of these polyisocyanate compounds may be used alone, or two or more of them may be used in combination.

The ratio of the polyisocyanate compound in terms of the equivalent ratio [NCO]/[OH] of the isocyanate groups [NCO] to the hydroxy groups [OH] in the amorphous polyester prepolymer having hydroxy groups is preferably from 1/1 to 5/1 inclusive, more preferably from 1.2/1 to 4/1 inclusive, and still more preferably from 1.5/1 to 2.5/1 inclusive.

In the amorphous polyester prepolymer having isocyanate groups, the content of a component derived from the polyisocyanate compound with respect to the total mass of the amorphous polyester prepolymer having isocyanate groups is preferably from 0.5% by mass to 40% by mass inclusive, more preferably from 1% by mass to 30% by mass inclusive, and still more preferably from 2% by mass to 20% by mass inclusive.

The average number of isocyanate groups per molecule of the amorphous polyester prepolymer having isocyanate groups is preferably 1 or more, more preferably from 1.5 to 3 inclusive, and still more preferably from 1.8 to 2.5 inclusive.

Examples of the amine compound to be reacted with the amorphous polyester prepolymer having isocyanate groups include diamines, polyamines having three or more amino groups, amino alcohols, amino mercaptans, amino acids, and these amines with a blocked amino group.

Examples of the diamines include: aromatic diamines (such as phenylenediamine, diethyltoluenediamine, and 4,4′-diaminodiphenylmethane); alicyclic diamines (such as 4,4′-diamino-3,3′-dimethyldicyclohexylmethane, diaminecyclohexane, and isophoronediamine); and aliphatic diamines (such as ethylenediamine, tetramethylenediamine, and hexamethylenediamine).

Examples of the polyamines having three or more amino groups include diethylenetriamine and triethylenetetramine.

Examples of the amino alcohols include ethanolamine and hydroxyethyl aniline.

Examples of the amino mercaptans include aminoethyl mercaptan and aminopropyl mercaptan.

Examples of the amino acids include aminopropionic acid and aminocaproic acid.

Examples of the amines with a blocked amino group include oxazoline compounds and ketimine compounds obtained from amine compounds such as diamines, polyamines having three or more amino groups, amino alcohols, amino mercaptans, and amino acids and ketone compounds (such as acetone, methyl ethyl ketone, and methyl isobutyl ketone).

Of these amine compounds, ketimine compounds may be used.

One of these amine compounds may be used alone, or two or more of them may be used in combination.

The urea-modified polyester resin may have a molecular weight controlled using a terminator that terminates at least one of the crosslinking reaction and the elongation reaction (the terminator is hereinafter referred to also as a “crosslinking/elongation reaction terminator”) to control the reaction of the amorphous polyester resin having isocyanate groups (amorphous polyester prepolymer) with the amine compound (at least one of the crosslinking reaction and the elongation reaction).

Examples of the crosslinking/elongation reaction terminator include monoamines (such as diethylamine, dibutylamine, butylamine, and laurylamine) and blocked compounds thereof (ketimine compounds).

The ratio of the amine compound in terms of the equivalent ratio [NCO]/[NHx] of the isocyanate groups [NCO] in the amorphous polyester prepolymer having isocyanate groups to the amino groups [NHx] in the amine is preferably from 1/2 to 2/1 inclusive, more preferably from 1/1.5 to 1.5/1 inclusive, and still more preferably from 1/1.2 to 1.2/1 inclusive.

The properties of the amorphous resin will be described.

The glass transition temperature (Tg) of the amorphous resin is preferably from 50° C. to 80° C. inclusive and more preferably from 50° C. to 65° C. inclusive.

The glass transition temperature is determined using a DSC curve obtained by differential scanning calorimetry (DSC). More specifically, the glass transition temperature is determined from “extrapolated glass transition onset temperature” described in a glass transition temperature determination method in “Testing methods for transition temperatures of plastics” in JIS K 7121-1987.

The weight average molecular weight (Mw) of the amorphous resin is preferably from 5000 to 1000000 inclusive and more preferably from 7000 to 500000 inclusive.

The number average molecular weight (Mn) of the amorphous resin may be from 2000 to 100000 inclusive.

The molecular weight distribution Mw/Mn of the amorphous resin is preferably from 1.5 to 100 inclusive and more preferably from 2 to 60 inclusive.

The weight average molecular weight and the number average molecular weight are measured by gel permeation chromatography (GPC). In the molecular weight distribution measurement by GPC, a GPC measurement apparatus HLC-8120GPC manufactured by TOSOH Corporation is used. A TSKgel Super HM-M (15 cm) column manufactured by TOSOH Corporation and a THF solvent are used. The weight average molecular weight and the number average molecular weight are computed from the measurement results using a molecular weight calibration curve produced using monodispersed polystyrene standard samples.

The acid value of the amorphous resin is preferably from 9 mgKOH/g to 15 mgKOH/g inclusive, more preferably from 10 mgKOH/g to 14 mgKOH/g inclusive, and still more preferably from 11 mgKOH/g to 13 mgKOH/g inclusive.

The dye is combined with the binder resin in the toner particles in some cases. In this case, the dye tends to be combined through acidic groups contained in the amorphous resin in the binder resin. When the acid value of the amorphous resin is within the above range, the amount of the acidic groups contained in the amorphous resin is small. Therefore, the dye is less likely to be combined with the amorphous resin, and the release agent is likely to be present on the surfaces of the toner particles. Thus, a sufficient amount of the release agent is likely to be supplied to the fixing member during fixation, and the difference in gloss between images when the images are formed continuously tends to be small.

The acid value of the amorphous resin is measured as follows.

The toner used as a measurement target is fixed onto a transparency, and then the amorphous resin is melted and separated at 60° C. The melted and separated amorphous resin is used to measure its acid value using a method prescribed in JIS K0070-1992 (a potentiometric titration method).

The acid value of a sample is the number of mg of potassium hydroxide required to neutralize acid groups (e.g., carboxyl groups) in 1 g of the sample.

The crystalline resin will be described.

Examples of the crystalline resin include well-known crystalline resins such as crystalline polyester resins and crystalline vinyl resins (such as polyalkylene resins and long chain alkyl (meth)acrylate resins). Of these, crystalline polyester resins are preferred from the viewpoint of the mechanical strength of the toner and its low-temperature fixability.

Crystalline Polyester Resin

The crystalline polyester resin is, for example, a polycondensation product of a polycarboxylic acid and a polyhydric alcohol. The crystalline polyester resin used may be a commercial product or a synthesized product.

To facilitate the formation of the crystalline structure in the crystalline polyester resin, a polycondensation product obtained using a polymerizable monomer having a linear aliphatic group is preferable to that obtained using a polymerizable monomer having an aromatic group.

Examples of the polycarboxylic acid include aliphatic dicarboxylic acids (such as oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid), aromatic dicarboxylic acids (for example, dibasic acids such as phthalic acid, isophthalic acid, terephthalic acid, and naphthalene-2,6-dicarboxylic acid), anhydrides thereof, and lower alkyl (having, for example, 1 to 5 carbon atoms) esters thereof.

The polycarboxylic acid used may be a combination of a dicarboxylic acid and a tricarboxylic or higher polycarboxylic acid having a crosslinked or branched structure. Examples of the tricarboxylic acid include aromatic carboxylic acids (such as 1,2,3-benzenetricarboxylic acid, 1,2,4-benzenetricarboxylic acid, and 1,2,4-naphthalene tricarboxylic acid), anhydrides thereof, and lower alkyl (having, for example, 1 to 5 carbon atoms) esters thereof.

The polycarboxylic acid used may be a combination of a dicarboxylic acid, a dicarboxylic acid having a sulfonic acid group, and a dicarboxylic acid having an ethylenic double bond.

One of these polycarboxylic acids may be used alone, or two or more of them may be used in combination.

The polyhydric alcohol is, for example, an aliphatic diol (e.g., a linear aliphatic diol with a main chain having 7 to 20 carbon atoms). Examples of the aliphatic diol include ethylene glycol, 1,3-propanediol, 1,4-butanediol, 1,5-pentanedial, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanedecanediol. In particular, the aliphatic diol is preferably 1,8-octanediol, 1,9-nonanediol, or 1,10-decanediol.

The polyhydric alcohol used may be a combination of a diol and a trihydric or higher polyhydric alcohol having a crosslinked or branched structure. Examples of the trihydric or higher polyhydric alcohol include glycerin, trimethylolethane, trimethylolpropane, and pentaerythritol.

One of these polyhydric alcohols may be used alone, or two or more of them may be used in combination.

In the polyhydric alcohol, the content of the aliphatic diol may be 80% by mole or more and preferably 90% by mole or more.

The melting temperature of the crystalline polyester resin is preferably from 50° C. to 100° C. inclusive, more preferably from 55° C. to 90° C. inclusive, and still more preferably from 60° C. to 85° C. inclusive.

The melting temperature is determined using a DSC curve obtained by differential scanning calorimetry (DSC) from “peak melting temperature” described in melting temperature determination methods in “Testing methods for transition temperatures of plastics” in JIS K7121-1987.

The weight average molecular weight (Mw) of the crystalline polyester resin may be from 6,000 to 35,000 inclusive.

Like, for example, the amorphous polyester resin, the crystalline polyester resin is obtained, for example, by a well-known production method.

The properties of the crystalline resin will be described.

The melting temperature of the crystalline resin is preferably from 50° C. to 100° C. inclusive, more preferably from 55° C. to 90° C. inclusive, and still more preferably from 60° C. to 85° C. inclusive.

The melting temperature is determined using a DSC curve obtained by differential scanning calorimetry (DSC) from “peak melting temperature” described in melting temperature determination methods in “Testing methods for transition temperatures of plastics” in JIS K7121-1987.

The weight average molecular weight (Mw) of the crystalline resin may be from 6000 to 35000 inclusive.

### —Dye—

The toner particles contain the dye.

The “dye” is a coloring agent whose solubility in 100 g of water at 23° C. or solubility in 100 g of cyclohexanone at 23° C. is 0.1 g or more.

In the present specification, the coloring agent is intended to encompass both a dye and a pigment.

No particular limitation is imposed on the dye, and examples of the dye include basic dyes, acidic dyes, mordant dyes, acidic mordant dyes, direct dyes, disperse dyes, sulfide dyes, vat dyes, azoic dyes, oxidation dyes, reactive dyes, oil-soluble dyes, food colors, natural dyes, and fluorescent brightening agents.

One of these dyes may be used alone, or two or more of them may be used in combination.

From the viewpoint of color forming properties, the dye may be a basic dye.

When the dye is a basic dye, the dye has a basic functional group, and therefore the dye and an acidic functional group in the binder resin tend to form an ionic bond. Therefore, when the dye is a basic dye, the difference in gloss that occurs when images are formed continuously tends to increase. However, in the toner according to the present exemplary embodiment, when a cross section of the toner particles is observed, the percentage of the release agent present in regions whose distances from the surfaces of the toner particles are 400 nm or less is from 25% to 50% inclusive with respect to the total amount of the release agent. Therefore, a sufficient amount of the release agent is likely to be supplied to the fixing member during fixation, and the toner is unlikely to adhere to the fixing member. Thus, even when the dye used is a basic dye, the difference in gloss that occurs when images are formed continuously is small.

When the dye is a basic dye and is at least one selected from rhodamine-based dyes having a cationic group and azo-based dyes having a cationic group, the dye and the binder resin are more easily combined with each other because the basicity of these basic dyes is particularly high. Therefore, the difference in gloss that occurs when images are formed continuously tends to increase. However, in the toner according to the present exemplary embodiment, when a cross section of the toner particles is observed, the percentage of the release agent present in the regions whose distances from the surfaces of the toner particles are 400 nm or more is from 25% to 50% inclusive with respect to the total amount of the release agent. Therefore, the difference in gloss that occurs when images are formed continuously is reduced because of the same reason as above.

The basic dye will be described specifically.

The basic dye is a dye having a cationic group.

The cationic group is preferably an onium group, more preferably an ammonium group, an iminium group, or a pyridinium group, still more preferably an ammonium group, and particularly preferably a quaternary ammonium group.

The basic dye may have only one cationic group or may have two or more cationic groups. From the viewpoint of fluorescence intensity, the basic dye has preferably 1 to 4 cationic groups, more preferably one or two cationic groups, and particularly preferably only one cationic group.

Specific examples of the basic dye include diazine-based dyes having a cationic group, oxazine-based dyes having a cationic group, thiazine-based dyes having a cationic group, azo-based dyes having a cationic group, anthraquinone-based dyes having a cationic group, rhodamine-based dyes having a cationic group, triarylmethane-based dyes having a cationic group, phthalocyanine-based dyes having a cationic group, auramine-based dyes having a cationic group, acridine-based dyes having a cationic group, and methine-based dyes having a cationic group.

More specific examples of the basic dye include dyes described below. For example, “Basic Red 2” is referred to also as “C.I. Basic Red 2.”

The diazine-based dye having a cationic group is a dye having, in its molecule, a cationic group and a diazine skeleton.

Specific examples of the diazine-based dye having a cationic group include Basic Red 2, 5, 6, and 10, Basic Blue 13, 14, and 16, Basic Violet 5, 6, 8, and 12, and Basic Yellow 14.

The oxazine-based dye having a cationic group is a dye having, in its molecule, a cationic group and an oxazine skeleton.

Specific example of the oxazine-based dye having a cationic group include Basic Blue 3, 6, 10, 12, and 74.

The thiazine-based dye having a cationic group is a dye having, in its molecule, a cationic group and a thiazine skeleton.

Specific examples of the thiazine-based dye having a cationic group include Basic Blue 9, 17, 24, and 25 and Basic Green 5.

The azo-based dye having a cationic group is a dye having, in its molecule, a cationic group and an azo group.

Specific examples of the azo-based dye having a cationic group include Basic Red 18, 22, 23, 24, 29, 30, 31, 32, 34, 38, 39, 46, 51, 53, 54, 55, 62, 64, 76, 94, 111, and 118, Basic Blue 41, 53, 54, 55, 64, 65, 66, 67, and 162, Basic Violet 18 and 36, Basic Yellow 15, 19, 24, 25, 28, 29, 38, 39, 49, 51, 57, 62, and 73, and Basic Orange 1, 2, 24, 25, 29, 30, 33, 54, and 69.

The anthraquinone-based dye having a cationic group is a dye having, in its molecule, a cationic group and an anthraquinone skeleton.

Specific examples of the anthraquinone-based dye having a cationic group include Basic Blue 22, 44, 47, and 72.

The rhodamine-based dye having a cationic group is a dye having, in its molecule, a cationic group and a rhodamine skeleton.

The rhodamine skeleton is a structure represented by the following formula (1).

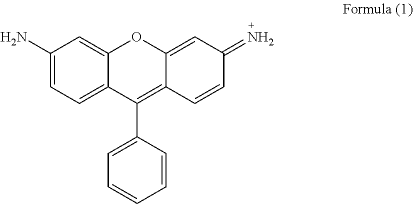 [SMILES: N=c1ccc2c(-c3ccccc3)c3ccc(N)cc3oc-2c1]

Specific examples of the rhodamine-based dye having a cationic group include Basic Red 1, 1:1, 3, 4, 8, and 11 and Basic Violet 10, 11, and 11:1.

The triarylmethane-based dye having a cationic group is a dye having, in its molecule, a cationic group and a triarylmethane skeleton. The triarylmethane skeleton is a structure having three aryl groups on one carbon atom.

Examples of the triarylmethane-based dye having a cationic group include Basic Red 9, Basic Blue 1, 2, 5, 7, 8, 11, 15, 18, 20, 23, 26, 35, and 81, Basic Violet 1, 2, 3, 4, 14, and 23, and Basic Green 1 and 4.

The phthalocyanine-based dye having a cationic group is a dye having, in its molecule, a cationic group and a phthalocyanine skeleton.

Specific examples of the phthalocyanine-based dye having a cationic group include Basic Blue 140.

The auramine-based dye having a cationic group is a dye having, in its molecule, a cationic group and an auramine skeleton.

Examples of the auramine-based dye having a cationic group include Basic Yellow 2, 3, and 37.

The acridine-based dye having a cationic group is a dye having, in its molecule, a cationic group and an acridine skeleton.

Examples of the acridine-based dye having a cationic group include Basic Yellow 5, 6, 7, and 9 and Basic Orange 4, 5, 14, 15, 16, 17, 18, 19, and 23.

The methine-based dye having a cationic group is a dye having, in its molecule, a cationic group and an indole skeleton.

Examples of the methine-based dye having a cationic group include Basic Red 12, 13, 14, 15, 27, 28, 37, 52, and 90, Basic Yellow 11, 13, 20, 21, 52, and 53, Basic Orange 21 and 22, and Basic Violet 7, 15, 16, 20, 21, and 22.

The ratio of the amount of the dye to the total amount of the toner particles is preferably from 5% by mass to 40% by mass inclusive, more preferably from 8% by mass to 30% by mass inclusive, and still more preferably form 10% by mass to 20% by mass inclusive.

### —Release Agent—

Examples of the release agent include: hydrocarbon-based waxes such as paraffin waxes, polyethylene waxes, and microcrystalline waxes; natural waxes such as carnauba wax, rice wax, and candelilla wax; synthetic and mineral/petroleum-based waxes such as montan wax; and ester-based waxes such as fatty acid esters and montanic acid esters. However, the release agent is not limited to these waxes.

The release agent may be at least one selected from the group consisting of paraffin waxes, polyethylene waxes, microcrystalline waxes, and ester based waxes.

When any of the above compounds is used as the release agent, good releasability and good hot offset resistance are obtained even when the content of the release agent in the toner particles is close the lower limit, so that the difference in gloss that occurs when images are formed continuously is further reduced.

The melting temperature of the release agent is preferably from 50° C. to 110° C. inclusive and more preferably from 60° C. to 100° C. inclusive.

The melting temperature is determined using a DSC curve obtained by differential scanning calorimetry (DSC) from “peak melting temperature” described in melting temperature determination methods in “Testing methods for transition temperatures of plastics” in JIS K7121-1987.

The content of the release agent with respect to the total mass of the toner particles is, for example, preferably from 1% by mass to 20% by mass inclusive, more preferably from 5% by mass to 10% by mass inclusive, and still more preferably from 6% by mass to 9% by mass inclusive.

When the content of the release agent is within the above range, an appropriate amount of the release agent can be easily supplied to the fixing member during fixation. Therefore, the toner is unlikely to adhere to the fixing member, and the difference in gloss between images when the images are formed continuously is further reduced.

[Percentage of Release Agent when Cross Section of Toner Particles is Observed]

Percentage of Release Agent in Regions Whose Distances from Surfaces of Toner Particles are 400 nm or Less

In the toner according to the present exemplary embodiment, when a cross section of the toner particles is observed, the percentage of the release agent present in the regions whose distances from the surfaces of the toner particles are 400 nm or less is from 20% to 50% inclusive with respect to the total amount of the release agent.

From the viewpoint of further reducing the difference in gloss that occurs when images are formed continuously, the percentage of the release agent present in the regions whose distances from the surfaces of the toner particles are 400 nm or less when a cross section of the toner particles is observed is preferably from 30% to 45% inclusive with respect to the total amount of the release agent, more preferably from 35% to 40% inclusive with respect to the total amount of the release agent, and still more preferably from 36% to 39% inclusive with respect to the total amount of the release agent.

In the cross section of the toner particles observed, the percentage (%) of the release agent present in the regions whose distances from the surfaces of the toner particles are 400 nm or less is the area fraction of the release agent in these regions with respect to the total area of the release agent in the toner particles.

Percentage of Release Agent Present in Regions Whose Distances from Surfaces of Toner Particle are 2 μm or More with Respect to Total Amount of Binder Resin

In the toner according to the present exemplary embodiment, when a cross section of the toner particles is observed, the percentage of the release agent present in regions whose distances from the surfaces of the toner particles are 2 μm or more is 1% or less with respect to the total amount of the binder resin.

In the cross section of the toner particles observed, the percentage of the release agent present in the regions whose distances from the surfaces of the toner particles are 2 μm or more with respect to the total amount of the binder resin is preferably from 0.1% to 0.95% inclusive, more preferably from 0.3% to 0.90% inclusive, and still more preferably from 0.5% to 0.90% inclusive, from the viewpoint of further reducing the difference in gloss that occurs when images are formed continuously.

In the cross section of the toner particles observed, the percentage (%) of the release agent present in the regions whose distances from the surfaces of the toner particles are 2 μm or more with respect to the total amount of the binder resin is the area fraction of the release agent in the regions whose distances from the surfaces are 2 μm or more with respect to the total area of the binder resin in the toner particles.

W1/W2 and W2/W3

In the toner according to the present exemplary embodiment, when a cross section of the toner particles is observed, formulas 1 and 2 below are satisfied. Here, W1 is the area of the release agent present in regions whose distances from the surfaces of the toner particles are less than 1 μm, and W2 is the area of the release agent present in regions whose distances from the surfaces of the toner particles are 1 μm or more and less than 2 μm. W3 is the area of the release agent present in regions whose distances from the surfaces of the toner particles are 2 μm or more.

1.5≤W1/W2 Formula 1:

4≤W2/W3 Formula 2:

From the viewpoint of further reducing the difference in gloss that occurs when images are formed continuously, W1, W2, and W3 satisfy preferably formulas 3 and 4 below, more preferably formulas 5 and 6 below, and still more preferably formulas 7 and 8 below.

1.6≤W1/W2≤2.5 Formula 3:

4.1≤W2/W3≤5 Formula 4:

1.7≤W1/W2≤2.3 Formula 5:

4.2≤W2/W3≤4.5 Formula 6:

1.8≤W1/W2≤2.1 Formula 7:

4.3≤W2/W3≤4.5 Formula 8:

In the present exemplary embodiment, “the percentage of the release agent present in regions whose distances from the surfaces of the toner particles are 400 nm or less,” “the percentage of the release agent present in regions whose distances from the surfaces of the toner particles are 2 μm or more,” and “W1/W2 and W2/W3” are examined by the following method.

First, the toner particles are embedded using a bisphenol A type liquid epoxy resin and a curing agent to produce a sample to be cut. The sample to be cut is cut at −100° C. using a cutting machine including a diamond knife such as LEICA ultramicrotome (manufactured by Hitachi High-Technologies Corporation) to produce an observation sample. The observation sample is left to stand in a desiccator with a ruthenium tetroxide atmosphere to stain the observation sample. Whether the sample has been stained is judged using the degree of staining of a tape left to stand together with the sample. The thus-stained observation sample is observed under a scanning transmission electron microscope (STEM).

Since the toner sample has been stained with ruthenium tetroxide, binder resin portions (regions other than the release agent and the coloring agent) and release agent portions are distinguished from each other based on the difference in shades of staining and the shapes of these portions. Rod-shaped whiter portions and lump-shaped whiter portions inside the toner are determined to be the release agent. Regions other than the release agent and the coloring agent are determined to be binder resin portions.

In a cross section of the toner particles in the observation sample, 20 toner particles are extracted using image processing software (WinROOF manufactured by MITANI CORPORATION) and used as measurement target toner particles. For each of the measurement target toner particles, the area of the release agent and the area of the binder resin are measured.

When “the percentage of the release agent in regions whose distances from the surface the toner particles are 400 nm or less” is computed, the areas of the release agent in the regions whose distances from the surfaces of the measurement target toner particles are computed, and the arithmetic mean of the measured areas is determined. The area fraction of the release agent in the regions whose distances from the particle surfaces are 400 nm or less is computed from the areas of the release agent in the toner particles.

When “the percentage of the release agent present in regions whose distances from the surfaces of the toner particles are 2 μm or more with respect to the total amount of the binder resin” is computed, the areas of the release agent in the regions whose distances from the surfaces of the measurement target toner particles are 2 μm are computed, and the total areas of the binder resin are also computed. Then the arithmetic mean of the measured areas of the release agent is determined to compute the mean area of the release agent present in the regions whose distances from the surfaces of the toner particles are 2 μm or more. Then the arithmetic mean of the measured total areas of the binder resin is determined to compute the mean total area of the binder resin in the toner particles. Then the area fraction of the release agent in the regions whose distances from the toner particle surfaces are 2 μm or more with respect to the total area of the binder resin in the toner particles is computed.

A method for computing “W1/W2 and W2/W3” will be described. The areas of the release agent present in regions whose distances from the surfaces of the measurement target toner particles are less than 1 μm are measured, and the arithmetic mean of the measured values is used as W1. The areas of the release agent present in regions whose distances from the surfaces of the measurement target toner particles are 1 μm or more and less than 2 μm are measured, and the arithmetic mean of the measured values is used as W2. The areas of the release agent present in regions whose distances from the surfaces of the measurement target toner particles are 2 μm or more are measured, and the arithmetic mean of the measured values is used as W3.

W1 is divided by W2 to compute W1/W2, and W2 is divided by W3 to compute W2/W3.

### —Additional Additives—

Examples of additional additives include well-known additives such as a magnetic material, a charge control agent, and an inorganic powder. These additives are contained in the toner particles as internal additives.

A pigment may be used as a coloring agent in combination with the dye.

Examples of the pigment include various pigments such as carbon black, chrome yellow, Hansa yellow, benzidine yellow, threne yellow, quinoline yellow, pigment yellow, permanent orange GTR, pyrazolone orange, vulcan orange, watchung red, permanent red, brilliant carmine 3B, brilliant carmine 6B, DuPont oil red, pyrazolone red, lithol red, rhodamine B lake, lake red C, pigment red, rose bengal, aniline blue, ultramarine blue, calco oil blue, methylene blue chloride, phthalocyanine blue, pigment blue, phthalocyanine green, and malachite green oxalate.

### —Content of Release Agent on Surfaces of Toner Particles—

In the toner according to the present exemplary embodiment, the ratio of the percentage of the release agent on the surfaces of the toner particles as measured by X-ray photoelectron spectroscopy to the percentage of the binder resin on the surfaces of the toner particles as measured by X-ray photoelectron spectroscopy is 10% or more.

From the viewpoint of further reducing the difference in gloss that occurs when images are formed continuously, the ratio of the percentage of the release agent on the surfaces of the toner particles as measured by X-ray photoelectron spectroscopy to the percentage of the binder resin on the surfaces of the toner particles as measured by X-ray photoelectron spectroscopy is preferably from 10% to 25% inclusive, more preferably from 10% to 20% inclusive, and still more preferably from 11% to 15% inclusive.

From the viewpoint of further reducing the difference in gloss that occurs when images are formed continuously, the percentage of the release agent on the surfaces of the toner particles as measured by X-ray photoelectron spectroscopy is preferably from 20% to 50% inclusive, more preferably from 25% to 45% inclusive, and still more preferably from 30% to 40% inclusive.

The percentages of the release agent and the binder resin on the surfaces of the toner particles are determined by XPS (X-ray photoelectron spectroscopy) measurement. The XPS measurement device used is JPS-9000MX manufactured by JEOL Ltd., and the measurement is performed using the MgKα line as an X-ray source at an acceleration voltage of 10 kV and an emission current of 30 mA.

First, attention is given to the percentage of carbon atoms to identify the release agent and the binder resin among the components contained in the toner particles in the toner used as the measurement target. Then each of the release agent and the binder resin contained in the toner particles in the toner used as the measurement target is independently subjected to XPS measurement to obtain a C1S spectrum. Next, the toner used as the measurement target is subjected to XPS measurement to quantify the percentages of the release agent and the binder resin on the surfaces of the toner particles.

The percentages of the release agent and the binder resin on the surfaces of the toner particles are quantified by subjecting the C1S spectrum to peak separation. In the peak separation method, the measured C1S spectrum is separated into individual components using least square curve fitting. For each of the release agent and the binder resin contained in the toner particles in the toner used as the measurement target, the C1S spectrum of the component alone measured in advance is used as a component spectrum for a base of the separation.

The percentage of the release agent on the surfaces of the toner particles as measured by X-ray photoelectron spectroscopy is the ratio of the C1S spectrum intensity of the release agent on the surfaces of the toner particles to the C1S spectrum intensity on the surfaces of the toner particles

The percentage of the binder resin on the surfaces of the toner particles as measured by X-ray photoelectron spectroscopy is the ratio of the CIS spectrum intensity of the binder resin on the surfaces of the toner particles to the CIS spectrum intensity on the surfaces of the toner particles.

—Properties Etc. Of Toner Particles—

The toner particles may have a single layer structure or may be core-shell toner particles having a so-called core-shell structure including a core (core particle) and a coating layer (shell layer) covering the core.

The toner particles having the core-shell structure may each include, for example: a core containing the binder resin and optional additives such as the coloring agent and the release agent; and a coating layer containing the binder resin.

The volume average particle diameter (D50v) of the toner particles is preferably from 2 μm to 10 μm inclusive and more preferably from 4 μm to 8 μm inclusive.

Various average particle diameters of the toner particles and their various particle size distribution indexes are measured using Coulter Multisizer II (manufactured by Beckman Coulter, Inc.), and ISOTON-II (manufactured by Beckman Coulter, Inc.) is used as an electrolyte.

In the measurement, 0.5 mg or more and 50 mg or less of a measurement sample is added to 2 mL of a 5% aqueous solution of a surfactant (for example, sodium alkylbenzenesulfonate) serving as a dispersant. The mixture is added to 100 mL or more and 150 mL or less of the electrolyte.

The electrolyte with the sample suspended therein is subjected to dispersion treatment for 1 minute using an ultrasonic dispersion apparatus, and then the particle size distribution of particles having diameters within the range of from 2 μm to 60 μm inclusive is measured using the Coulter Multisizer II with an aperture having an aperture diameter of 100 μm. The number of particles sampled is 50000.

The particle size distribution measured and divided into particle size ranges (channels) is used to obtain volume-based and number-based cumulative distributions computed from the small diameter side. In the volume-based cumulative distribution, the particle diameter at a cumulative frequency of 16% is defined as a volume-based particle diameter D16v, and the particle diameter at a cumulative frequency of 50% is defined as a volume average particle diameter D50v. Moreover, the particle diameter at a cumulative frequency of 84% is defined as a volume-based particle diameter D84v. In the number-based cumulative distribution, the particle diameter at a cumulative frequency of 16% is defined as a number-based diameter D16p, and the particle diameter at a cumulative frequency of 50% is defined as a number average cumulative particle diameter D50p. Moreover, the particle diameter at a cumulative frequency of 84% is defined as a number-based diameter D84p.

These are used to compute a volume-based particle size distribution index (GSDv) defined as (D84v/D16v)^{1/2} and a number-based particle size distribution index (GSDp) defined as (D84p/D16p)^{1/2}.

The average circularity of the toner particles is preferably from 0.94 to 1.00 inclusive and more preferably from 0.95 to 0.98 inclusive.

The circularity of a toner particle is determined as (the peripheral length of an equivalent circle of the toner particle)/(the peripheral length of the toner particle) [i.e., (the peripheral length of a circle having the same area as a projection image of the particle)/(the peripheral length of the projection image of the particle)]. Specifically, the average circularity is a value measured by the following method.

First, the toner particles used for the measurement are collected by suction, and a flattened flow of the particles is formed. Particle images are captured as still images using flashes of light, and the average circularity is determined by subjecting the particle images to image analysis using a flow-type particle image analyzer (FPIA-3000 manufactured by SYSMEX Corporation). The number of particles sampled for determination of the average circularity is 3500.

When the toner contains the external additive, the toner (developer) for the measurement is dispersed in water containing a surfactant, and the dispersion is subjected to ultrasonic treatment. The toner particles with the external additive removed are thereby obtained.

### (External Additive)

Examples of the external additive include inorganic particles. Examples of the inorganic particles include SiO₂, TiO₂, Al₂O₃, CuO, ZnO, SnO₂, CeO₂, Fe₂O₃, MgO, BaO, CaO, K₂O, Na₂O, ZrO₂, CaO.SiO₂, K₂O.(TiO₂)ₙ, Al₂O₃.2SiO₂, CaCO₃, MgCO₃, BaSO₄, and MgSO₄.

The surface of the inorganic particles used as the external additive may be subjected to hydrophobic treatment. The hydrophobic treatment is performed, for example, by immersing the inorganic particles in a hydrophobic treatment agent. No particular limitation is imposed on the hydrophobic treatment agent, and examples thereof include silane-based coupling agents, silicone oils, titanate-based coupling agents, and aluminum-based coupling agents. Any of these coupling agents may be used alone or in combination of two or more.

The amount of the hydrophobic treatment agent is generally, for example, from 1 part by mass to 10 parts by mass inclusive based on 100 parts by mass of the inorganic particles.

Other examples of the external additive include resin particles (particles of resins such as polystyrene, polymethyl methacrylate (PMMA), and melamine resins) and a cleaning activator (a metal salt of a higher fatty acid typified by zinc stearate or particles of a fluorine-based high-molecular weight material).

The amount of the external additives is, for example, preferably from 0.01% by mass to 5% by mass inclusive and more preferably from 0.01% by mass to 2.0% by mass inclusive based on the mass of the toner particles.

### (Method for Producing Toner)

Next, a method for producing the toner according to the present exemplary embodiment will be described.

The toner according to the present exemplary embodiment is obtained by producing toner particles and then externally adding the external additive to the toner particles produced.

The toner particles may be produced by a dry production method (such as a kneading-grinding method) or by a wet production method (such as an aggregation/coalescence method, a suspension polymerization method, or a dissolution/suspension method). No particular limitation is imposed on the toner particle production method, and any known production method may be used.

From the viewpoint of adjusting the amount of the release agent present in regions whose distances from the surfaces of the toner particles are 400 nm or less to be from 25% to 50% inclusive when a cross section of the toner particles is observed, the aggregation/coalescence method may be used to obtain the toner particles.

Specifically, when the toner particles are produced, for example, by the aggregation/coalescence method, the toner particles may be produced through:

the step of preparing dispersions (a dispersion preparing step);

the step of forming first aggregated particles by mixing a first resin particle dispersion in which first resin particles used as a binder resin are dispersed, a coloring agent dispersion in which the coloring agent (the dye and an optional pigment) is dispersed, and a release agent particle dispersion in which particles of the release agent (hereinafter may be referred to also as “release agent particles” are dispersed to thereby aggregate these particles and the coloring agent in the resulting dispersion (a first aggregated particle forming step);

the step of, after the first aggregated particle dispersion containing the first aggregated particles dispersed therein has been obtained, forming second aggregated particles by adding second resin particles used as a binder resin and the release agent particle dispersion to the first aggregated particle dispersion to cause the second resin particles and the release agent particles to be further aggregated on the surfaces of the first aggregated particles (a second aggregated particle forming step);

the step of, after the second aggregated particle dispersion containing the second aggregated particles dispersed therein has been obtained, forming third aggregated particles by adding third resin particles used as a binder resin to the second aggregated particle dispersion to cause the third resin particles to be further aggregated on the surfaces of the second aggregated particles (a third aggregated particle forming step); and

the step of forming the toner particles by heating the third aggregated particle dispersion containing the third aggregated particles dispersed therein to fuse and coalesce the third aggregated particles (a fusion/coalescence step).

### —Dispersion Preparing Step—

The dispersions used for the aggregation/coalescence method are prepared. Specifically, the first resin particle dispersion in which the first resin particles used as a binder resin are dispersed, the coloring agent dispersion in which the coloring agent is dispersed, a second resin particle dispersion in which the second resin particles used as a binder resin are dispersed, the release agent particle dispersion in which the release agent particles are dispersed, and a third resin particle dispersion in which the third resin particles used as a binder resin are dispersed are prepared.

In the description of the dispersion preparing step, the first resin particles, the second resin particles, and the third resin particles are collectively referred to as “resin particles.”

Each of the resin particle dispersions is prepared, for example, by dispersing resin particles in a dispersion medium using a surfactant.

Examples of the dispersion medium used for the resin particle dispersions include aqueous mediums.

Examples of the aqueous medium include: water such as distilled water and ion exchanged water; and alcohols. One of these aqueous mediums may be used alone, or two or more of them may be used in combination.

Examples of the surfactant include: anionic surfactants such as sulfate-based surfactants, sulfonate-based surfactants, phosphate-based surfactants, and soap-based surfactants; cationic surfactants such as amine salt-based surfactants and quaternary ammonium salt-based surfactants; and nonionic surfactants such as polyethylene glycol-based surfactants, alkylphenol ethylene oxide adduct-based surfactants, and polyhydric alcohol-based surfactants. Of these, an anionic surfactant or a cationic surfactant may be used. A nonionic surfactant may be used in combination with the anionic surfactant or the cationic surfactant.

One of these surfactants may be used alone, or two or more of them may be used in combination.

To disperse resin particles in the dispersion medium to form a resin particle dispersion, a commonly used dispersing method that uses, for example, a rotary shearing-type homogenizer, a ball mill using media, a sand mill, or a dyno-mill may be used. The resin particles may be dispersed in the dispersion medium by, for example, a phase inversion emulsification method, but this depends on the type of resin particles.

In the phase inversion emulsification method, the resin to be dispersed is dissolved in a hydrophobic organic solvent that can dissolve the resin, and a base is added to an organic continuous phase (O phase) to neutralize it. Then the aqueous medium (W phase) is added to change the form of the resin from W/O to O/W (so-called phase inversion) to thereby form a discontinuous phase, and the resin is thereby dispersed as particles in the aqueous medium.

The volume average particle diameter of resin particles dispersed in each resin particle dispersion is, for example, preferably from 0.01 μm to 1 μm inclusive, more preferably from 0.08 μm to 0.8 μm inclusive, and still more preferably from 0.1 μm to 0.6 μm inclusive.

The volume average particle diameter of the resin particles is measured as follows. A particle size distribution measured by a laser diffraction particle size measurement apparatus (e.g., LA-700 manufactured by HORIBA Ltd.) is used and divided into different particle diameter ranges (channels), and a cumulative volume distribution computed from the small particle diameter side is determined. The particle diameter at a cumulative frequency of 50% is measured as the volume average particle diameter D50v. The volume average particle diameters of particles in other dispersions are measured in the same manner.

The content of resin particles contained in a resin particle dispersion is, for example, preferably from 5% by mass to 50% by mass inclusive and more preferably from 10% by mass to 40% by mass inclusive.

For example, the coloring agent dispersion and the release agent particle dispersion are prepared in a similar manner to the resin particle dispersions. Specifically, the descriptions of the volume average particle diameter of the particles in each of the resin particle dispersions, the dispersion medium for the resin particle dispersions, the dispersing method, and the content of the resin particles are applicable to the coloring agent dispersed in the coloring agent dispersion and the release agent particles dispersed in the release agent particle dispersion.

### —First Aggregated Particle Forming Step—

Next, the first resin particle dispersion, the coloring agent dispersion, and the release agent particle dispersion are mixed.

Then the first resin particles, the coloring agent, and the release agent particles are hetero-aggregated in the dispersion mixture to form first aggregated particles containing the first resin particles, the coloring agent, and the release agent particles.

Specifically, for example, a flocculant is added to the dispersion obtained by mixing the first resin particle dispersion and the coloring agent dispersion, and the pH of the dispersion mixture is adjusted to acidic (for example, a pH of from 2 to 5 inclusive). Then a dispersion stabilizer is optionally added, and the resulting mixture is brought to a temperature range of from 20° C. to 50° C. inclusive. Then the release agent particle dispersion is added, and the particles dispersed in the dispersion mixture are aggregated to form the first aggregated particles.

In the first aggregated particle forming step, the flocculant may be added at room temperature (e.g., 25° C.) while the dispersion mixture is agitated, for example, in a rotary shearing-type homogenizer. Then the pH of the dispersion mixture is adjusted to acidic (e.g., a pH of from 2 to 5 inclusive), and the dispersion stabilizer is optionally added. Then the resulting mixture is heated in the manner described above.

Examples of the flocculant include a surfactant with polarity opposite to the polarity of the surfactant added to the dispersion mixture, inorganic metal salts, and divalent or higher polyvalent metal complexes. In particular, when a metal complex is used as the flocculant, the amount of the surfactant used can be reduced, and charging characteristics may be improved.

An additive that forms a complex with a metal ion in the flocculant or a similar bond may be optionally used. The additive used may be a chelating agent.

Examples of the inorganic metal salts include: metal salts such as calcium chloride, calcium nitrate, barium chloride, magnesium chloride, zinc chloride, aluminum chloride, and aluminum sulfate; and inorganic metal salt polymers such as polyaluminum chloride, polyaluminum hydroxide, and calcium polysulfide.

The chelating agent used may be a water-soluble chelating agent. Examples of the chelating agent include: oxycarboxylic acids such as tartaric acid, citric acid, and gluconic acid; iminodiacetic acid (IDA); nitrilotriacetic acid (NTA); and ethylenediaminetetraacetic acid (EDTA).

The amount of the chelating agent added is, for example, preferably from 0.01 parts by mass to 5.0 parts by mass inclusive and more preferably 0.1 parts by mass or more and less than 3.0 parts by mass based on 100 parts by mass of the first resin particles.

### —Second Aggregated Particle Forming Step—

Next, after the first aggregated particle dispersion containing the first aggregated particles dispersed therein has been obtained, a dispersion mixture containing the second resin particles and the release agent particles dispersed therein is added to the first aggregated particle dispersion.

The second resin particles may be the same as or different from the first resin particles.

Then, in the dispersion containing the first aggregated particles, the second resin particles, and the release agent particle, the second resin particles and the release agent particles are aggregated on the surfaces of the first aggregated particles. Specifically, for example, when the diameter of the first aggregated particles has reached a target value in the first aggregated particle forming step, the dispersion mixture containing the second resin particles and the release agent particles dispersed therein is added to the first aggregated particle dispersion, and the resulting dispersion is subjected to aggregation in a temperature range of from 45° C. to 50° C. inclusive.

The second aggregated particles with the second resin particles and the release agent particles aggregated so as to adhere to the surfaces of the first aggregated particles is thereby obtained.

### —Third Aggregated Particle Forming Step—

After the second aggregated particle dispersion containing the second aggregated particles dispersed therein has been obtained, the third resin particles used as a binder resin are added to the second aggregated particle dispersion.

The third resin particles may be the same as or different from the first resin particles and the second resin particles.

In the dispersion containing the second aggregated particles and the third resin particles dispersed therein, the third resin particles are aggregated on the surfaces of the second aggregated particles. Specifically, for example, when the diameter of the second aggregated particles has reached a target value in the second aggregated particle forming step, the third resin particles are added to the second aggregated particle dispersion, and the resulting dispersion is heated to a temperature equal to or lower than the glass transition temperature of the third resin particles.

Then the pH of the dispersion is adjusted to the range of, for example, from about 6.5 to about 8.5 inclusive to stop the progress of aggregation.

### —Fusion/Coalescence Step—

Next, the third aggregated particle dispersion containing the third aggregated particles dispersed therein is heated to, for example, a temperature equal to or higher than the glass transition temperatures of the first, second, and third resin particles (e.g., a temperature higher by 10° C. to 30° C. than the glass transition temperatures of the first, second, and third resin particles) to fuse and coalesce the third aggregated particles to thereby form toner particles.

The toner particles are obtained through the above-described steps.

Alternatively, the toner particles may be produced through: the step of forming fourth aggregated particles by, after the third aggregated particle dispersion containing the third aggregated particles dispersed therein has been obtained, mixing the third aggregated particle dispersion with a fourth resin particle dispersion in which fourth resin particles used as a binder resin are dispersed to aggregate the fourth resin particles such that the fourth resin particles adhere to the surfaces of the third aggregated particles; and the step of forming toner particles having a core-shell structure by heating the fourth aggregated particle dispersion containing the fourth aggregated particles dispersed therein to fuse and coalesce the fourth aggregated particles.

In the toner particles (toner) obtained by the above procedure, when a cross section of the toner particles is observed, the percentage of the release agent present in regions whose distances from the surfaces of the toner particles are 400 nm or less is from 25% to 50% inclusive with respect to the total amount of the release agent.

After completion of the fusion/coalescence step, the toner particles formed in the solution are subjected to a well-known washing step, a well-known solid-liquid separation step, and a well-known drying step to thereby obtain dried toner particles.

From the viewpoint of chargeability, the toner particles may be subjected to displacement washing with ion exchanged water sufficiently in the washing step. No particular limitation is imposed on the solid-liquid separation step. From the viewpoint of productivity, suction filtration, pressure filtration, etc. may be performed in the solid-liquid separation step. No particular limitation is imposed on the drying step. From the viewpoint of productivity, freeze-drying, flash jet drying, fluidized drying, vibrating fluidized drying, etc. may be used.

Next, the production of toner particles containing the urea-modified polyester resin (the urea-modified amorphous polyester resin) will be described.

The toner particles containing the urea-modified polyester resin may be obtained by a solution suspension method described below. A method for obtaining toner particles containing, as the binder resin, the urea-modified polyester resin (the urea-modified amorphous polyester resin) and an unmodified crystalline polyester resin will be described, but the toner particles may contain, as the binder resin, an unmodified amorphous polyester resin. [Oil phase solution preparing step]

An oil phase solution is prepared by dissolving or dispersing toner particle materials including the unmodified crystalline polyester resin (hereinafter referred to simply as a “crystalline polyester resin”), the amorphous polyester prepolymer having isocyanate groups, the amine compound, the coloring agent, and the release agent in an organic solvent (an oil phase solution preparing step). In the oil phase solution preparing step, the toner particle materials are dissolved or dispersed in the organic solvent to obtain a toner material solution mixture.

Examples of the method for preparing the oil phase solution include: 1) an oil phase solution preparation method including dissolving or dispersing the toner particle materials at once in the organic solvent; 2) an oil phase solution preparation method including kneading the toner particle materials in advance and dissolving or dispersing the kneaded product in the organic solvent; 3) an oil phase solution preparation method including dissolving the crystalline polyester resin, the amorphous polyester prepolymer having isocyanate groups, and the amine compound in the organic solvent and then dispersing the coloring agent and the release agent in the resulting organic solvent; 4) an oil phase solution preparation method including dispersing the coloring agent and the release agent in the organic solvent and then dissolving the crystalline polyester resin, the amorphous polyester prepolymer having isocyanate groups, and the amine compound in the resulting organic solvent; 5) an oil phase solution preparation method including dissolving or dispersing the toner particle materials other than the amorphous polyester prepolymer having isocyanate groups and the amine compound (the crystalline polyester resin, the coloring agent, and the release agent) in the organic solvent and then dissolving the amorphous polyester prepolymer having isocyanate groups and the amine compound in the resulting organic solvent; and 6) an oil phase solution preparation method including dissolving or dispersing the toner particle materials other than the amorphous polyester prepolymer having isocyanate groups or the amine compound (the crystalline polyester resin, the coloring agent, and the release agent) in the organic solvent and then dissolving the amorphous polyester prepolymer having isocyanate groups or the amine compound in the resulting organic solvent. However, the method for preparing the oil phase solution is not limited to the above methods.

Examples of the organic solvent in the oil phase solution include: ester-based solvents such as methyl acetate and ethyl acetate; ketone-based solvents such as methyl ethyl ketone and methyl isopropyl ketone; aliphatic hydrocarbon-based solvents such as hexane and cyclohexane; and halogenated hydrocarbon-based solvents such as dichloromethane, chloroform, and trichloroethylene. These organic solvents can dissolve the binder resin and may have a solubility in water of from about 0% by mass to about 30% by mass inclusive and a boiling point of 100° C. or less. Among these organic solvents, ethyl acetate may be used.

### —Suspension Preparing Step—

Next, the obtained oil phase solution is dispersed in an water phase solution to prepare a suspension (a suspension preparing step).

While the suspension is prepared, the amorphous polyester prepolymer having isocyanate groups is reacted with the amine compound. The urea-modified polyester resin is generated through this reaction. This reaction involves at least one of the crosslinking reaction and elongation reaction of the molecular chain. The reaction of the amorphous polyester prepolymer having isocyanate groups with the amine compound may be performed during an organic solvent removing step described later.

The reaction conditions are selected according to the reactivity between the isocyanate group structure included in the amorphous polyester prepolymer and the amine compound. For example, the reaction time is preferably from 10 minutes to 40 hours inclusive and preferably from 2 hours to 24 hours inclusive. The reaction temperature is preferably from 0° C. to 150° C. inclusive and preferably from 40° C. to 98° C. inclusive. To produce the urea-modified polyester resin, a well-known catalyst (such as dibutyltin laurate or dioctyltin laurate) may be optionally used. Specifically, a catalyst may be added to the oil phase solution or the suspension.

One example of the water phase solution is a water phase solution obtained by dissolving a particle dispersant such as an organic particle dispersant or an inorganic particle dispersant in an aqueous solvent. Another example of the water phase solution is a water phase solution obtained by dispersing a particle dispersant in an aqueous solvent and dissolving a polymer dispersant in the resulting aqueous solvent. A well-known additive such as a surfactant may be added to the water phase solution.

Examples of the aqueous solvent include water (generally, for example, ion exchanged water, distilled water, and pure water). The aqueous solvent may be a solvent containing, in addition to water, an organic solvent such as an alcohol (such as methanol, isopropyl alcohol, or ethylene glycol), dimethylformamide, tetrahydrofuran, a cellosolve (such as methyl cellosolve), or a lower ketone (such as acetone or methyl ethyl ketone).

Examples of the organic particle dispersant include hydrophilic organic particle dispersants. Other examples of the organic particle dispersant include particles of alkyl poly(meth)acrylate resins (such as a polymethyl methacrylate resin), polystyrene resins, and poly(styrene-acrylonitrile) resins. Another example of the organic particle dispersant is particles of a styrene acrylic resin.

Examples of the inorganic particle dispersant include hydrophilic inorganic particle dispersants. Specific examples of the inorganic particle dispersant include particles of silica, alumina, titania, calcium carbonate, magnesium carbonate, tricalcium phosphate, clay, diatomaceous earth, bentonite, etc. The inorganic particle dispersant may be particles of calcium carbonate. One of these inorganic particle dispersants may be used alone, or two or more of them may be used in combination.

The particle dispersant may be surface-treated with a polymer having a carboxyl group.

Examples of the polymer having a carboxyl group include copolymers of an α,β-monoethylenically unsaturated carboxylic acid ester with an α,β-monoethylenically unsaturated carboxylic acid or at least one selected from salts (such as alkali metal salts, alkaline earth metal salts, ammonium salts, and amine salts) obtained by neutralizing a carboxyl group in an α,β-monoethylenically unsaturated carboxylic acid with an alkali metal, an alkaline earth metal, ammonium, or amine. Other examples of the polymer having a carboxyl group include salts (such as alkali metal salts, alkaline earth metal salts, ammonium salts, and amine salts) obtained by neutralizing carboxyl groups in a copolymer of an α,β-monoethylenically unsaturated carboxylic acid and an α,β-monoethylenically unsaturated carboxylic acid ester with an alkali metal, an alkaline earth metal, ammonium or amine. One of these polymers having a carboxyl group may be used alone, or two or more of them may be used in combination.

Representative examples of the α,β-monoethylenically unsaturated carboxylic acid include α,β-unsaturated monocarboxylic acids (such as acrylic acid, methacrylic acid, and crotonic acid) and α,β-unsaturated dicarboxylic acids (such as maleic acid, fumaric acid, and itaconic acid). Representative examples of the α,β-monoethylenically unsaturated carboxylic acid ester include alkyl esters of (meth)acrylic acid, (meth)acrylates having an alkoxy group, (meth)acrylates having a cyclohexyl group, (meth)acrylates having a hydroxy group, and polyalkylene glycol mono(meth)acrylates.

Examples of the polymer dispersant include hydrophilic polymer dispersants. Specific examples of the polymer dispersant include polymer dispersants having a carboxyl group and not having a lipophilic group (such as a hydroxypropoxy group or a methoxy group) (e.g., water-soluble cellulose ethers such as carboxymethyl cellulose and carboxyethyl cellulose).

### —Solvent Removing Step—

Next, the organic solvent is removed from the obtained suspension to thereby obtain a toner particle dispersion (a solvent removing step). In the solvent removing step, the organic solvent contained in liquid droplets of the water phase solution dispersed in the suspension is removed to form toner particles. The organic solvent may be removed from the suspension immediately after the suspension preparing step or may be removed at least one minute after completion of the suspension preparing step.

In the solvent removing step, the organic solvent may be removed from the obtained suspension by cooling or heating the suspension in the range of, for example, from 0° C. to 100° C. inclusive.

Specific examples of a method for removing the organic solvent include the following methods.

(1) A method including blowing air onto the suspension to forcibly renew the gas phase on the surface of the suspension. In this case, the gas may be blown into the suspension.

(2) A method including reducing the pressure. In this case, the gas phase on the surface of the suspension may be forcibly renewed by charging a gas. The gas may be blown into the suspension.

The toner according to the present exemplary embodiment is produced, for example, by adding an external additive to the obtained dry toner particles and mixing them. The mixing may be performed using a V blender, a Henschel mixer, a Loedige mixer, etc. If necessary, coarse particles in the toner may be removed using a vibrating sieve, a wind sieve, etc.

The toner particles are obtained through the above steps.

After completion of the solvent removing step, the toner particles formed in the toner particle dispersion are subjected to well-known washing, solid-liquid separation, and drying steps to thereby obtain dried toner particles.

From the viewpoint of chargeability, the toner particles may be subjected to displacement washing with ion exchanged water sufficiently in the washing step.

No particular limitation is imposed on the solid-liquid separation step. From the viewpoint of productivity, suction filtration, pressure filtration, etc. may be performed in the solid-liquid separation step. No particular limitation is imposed on the drying step. From the viewpoint of productivity, freeze-drying, flash drying, fluidized drying, vibrating fluidized drying, etc. may be performed in the drying step.

### <Electrostatic Image Developer>

An electrostatic image developer according to an exemplary embodiment contains at least the toner according to the preceding exemplary embodiment.

The electrostatic image developer according to the present exemplary embodiment may be a one-component developer containing only the toner according to the preceding exemplary embodiment or a two-component developer containing the toner and a carrier.

No particular limitation is imposed on the carrier, and a well-known carrier may be used. Examples of the carrier include: a coated carrier prepared by coating the surface of a core material formed of a magnetic powder with a coating resin; a magnetic powder-dispersed carrier prepared by dispersing a magnetic powder in a matrix resin; and a resin-impregnated carrier prepared by impregnating a porous magnetic powder with a resin.

In each of the magnetic powder-dispersed carrier and the resin-impregnated carrier, the particles included in the carrier may be used as cores, and the cores may be coated with a coating resin.

Examples of the magnetic powder include: magnetic metal powders such as iron powder, nickel powder, and cobalt powder; and magnetic oxide powders such as ferrite powder and magnetite powder.

Examples of the coating resin and the matrix resin include polyethylene, polypropylene, polystyrene, polyvinyl acetate, polyvinyl alcohol, polyvinyl butyral, polyvinyl chloride, polyvinyl ether, polyvinyl ketone, vinyl chloride-vinyl acetate copolymers, styrene-acrylate copolymers, straight silicone resins having organosiloxane bonds and modified products thereof, fluorocarbon resins, polyesters, polycarbonates, phenolic resins, and epoxy resins.

The coating resin and the matrix resin may contain an additional additive such as electrically conductive particles.

Examples of the electrically conductive particles include: particles of metals such as gold, silver, and copper; and particles of carbon black, titanium oxide, zinc oxide, tin oxide, barium sulfate, aluminum borate, and potassium titanate.

One example of the method for coating the surface of the core material with the coating resin is a method in which the surface of the core material is coated with a coating layer-forming solution prepared by dissolving the coating resin and various optional additives in an appropriate solvent. No particular limitation is imposed on the solvent, and the solvent may be selected in consideration of the type of resin used, ease of coating, etc.

Specific examples of the resin coating method include: an immersion method in which the core material is immersed in the coating layer-forming solution; a spray method in which the coating layer-forming solution is sprayed onto the surface of the core material; a fluidized bed method in which the coating layer-forming solution is sprayed onto the core material floated by the flow of air; and a kneader-coater method in which the core material of the carrier and the coating layer-forming solution are mixed in a kneader coater and then the solvent is removed.

The mixing ratio (mass ratio) of the toner and the carrier in the two-component developer is preferably toner:carrier=1:100 to 30:100 and more preferably 3:100 to 20:100.

### <Image Forming Apparatus/Image Forming Method>

An image forming apparatus according to an exemplary embodiment/an image forming method according to an exemplary embodiment will be described.

The image forming apparatus according to the present exemplary embodiment includes: an image holding member; charging means for charging the surface of the image holding member; electrostatic image forming means for forming an electrostatic image on the charged surface of the image holding member; developing means that contains an electrostatic image developer and develops the electrostatic image formed on the surface of the image holding member with the electrostatic image developer to thereby form a toner image; transferring means for transferring the toner image formed on the surface of the image holding member onto a recording medium; and fixing means for fixing the toner image transferred onto the recording medium. The electrostatic image developer used is the electrostatic image developer according to the preceding exemplary embodiment.

In the image forming apparatus according to the present exemplary embodiment, an image forming method (an image forming method according to the present exemplary embodiment) is performed. The image forming method includes: charging the surface of the image holding member; forming an electrostatic image on the charged surface of the image holding member; developing the electrostatic image formed on the surface of the image holding member with the electrostatic image developer according to the preceding exemplary embodiment to thereby form a toner image; transferring the toner image formed on the surface of the image holding member onto a recording medium; and fixing the toner image transferred onto the surface of the recording medium.

The image forming apparatus according to the present exemplary embodiment is applied to known image forming apparatuses such as: a direct transfer-type apparatus that transfers a toner image formed on the surface of the image holding member directly onto a recording medium; an intermediate transfer-type apparatus that first-transfers a toner image formed on the surface of the image holding member onto the surface of an intermediate transfer body and second-transfers the toner image transferred onto the surface of the intermediate transfer body onto the surface of a recording medium; an apparatus including cleaning means for cleaning the surface of the image holding member after the transfer of the toner image but before charging; and an apparatus including charge eliminating means for eliminating charges on the surface of the image holding member after transfer of the toner image but before charging by irradiating the surface of the image holding member with charge eliminating light.

In the intermediate transfer-type apparatus, the transferring means includes, for example: an intermediate transfer body having a surface onto which a toner image is to be transferred; first transferring means for first-transferring a toner image formed on the surface of the image holding member onto the surface of the intermediate transfer body; and second transferring means for second-transferring the toner image transferred onto the surface of the intermediate transfer body onto the surface of a recording medium.

In the image forming apparatus according to the present exemplary embodiment, for example, a portion including the developing means may have a cartridge structure (process cartridge) that is detachably attached to the image forming apparatus. The process cartridge used may be, for example, a process cartridge including the developing means containing the electrostatic image developer according to the preceding exemplary embodiment.

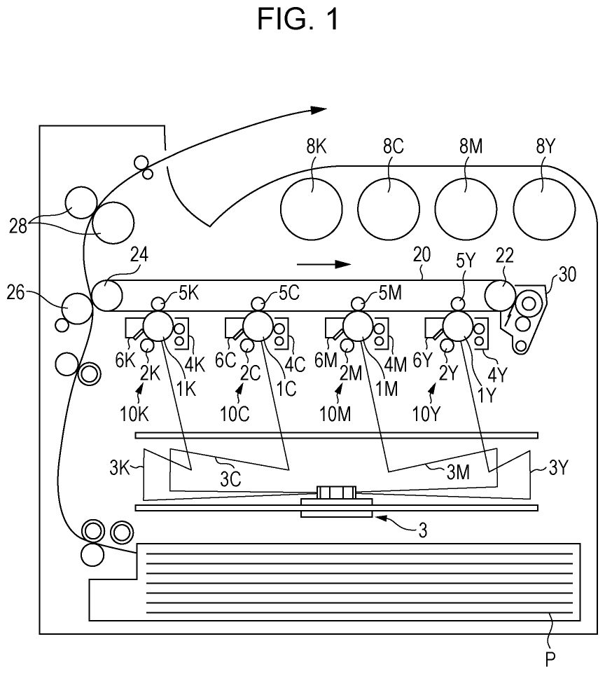

An example of the image forming apparatus according to the present exemplary embodiment will be described, but this is not a limitation. Major components shown in FIG. 1 will be described, and description of other components will be omitted.

FIG. 1 a schematic configuration diagram showing the image forming apparatus according to the present exemplary embodiment.

The image forming apparatus shown in FIG. 1 includes first to fourth electrophotographic image forming units 10Y, 10M, 10C, and 10K (image forming means) that output yellow (Y), magenta (M), cyan (C), and black (K) images, respectively, based on color-separated image data. These image forming units (hereinafter may be referred to simply as “units”) 10Y, 10M, 10C, and 10K are arranged so as to be spaced apart from each other horizontally by a prescribed distance. These units 10Y, 10M, 10C, and 10K may each be a process cartridge detachably attached to the image forming apparatus.

An intermediate transfer belt 20 serving as the intermediate transfer body is disposed above the units 10Y, 10M, 10C, and 10K in FIG. 1 so as to extend through these units. The intermediate transfer belt 20 is wound around a driving roller 22 and a support roller 24 that are disposed so as to be spaced apart from each other in the left-right direction in FIG. 1 and runs in a direction from the first unit 10Y toward the fourth unit 10K, and the support roller 24 is in contact with the inner surface of the intermediate transfer belt 20. A force is applied to the support roller 24 by, for example, an unillustrated spring in a direction away from the driving roller 22, so that a tension is applied to the intermediate transfer belt 20 wound around the rollers. An intermediate transfer body cleaner 30 is disposed on the image holding member-side surface of the intermediate transfer belt 20 so as to be opposed to the driving roller 22.

Four color toners including yellow, magenta, cyan, and black toners contained in toner cartridges 8Y, 8M, 8C, and 8K, respectively, are supplied to developing devices (examples of the developing means) 4Y, 4M, 4C, and 4K, respectively, of the units 10Y, 10M, 10C, and 10K.

The first to fourth units 10Y, 10M, 10C, and 10K have the same structure. Therefore, the first unit 10Y that is disposed upstream in the running direction of the intermediate transfer belt and forms a yellow image will be described as a representative unit. Description of the second to fourth units 10M, 10C, 10K will be omitted by replacing Y (yellow) in the reference symbol in the first unit 10Y with M (magenta), C (cyan), or K (black).

The first unit 10Y includes a photoconductor 1Y serving as an image holding member. A charging roller (an example of the charging means) 2Y, an exposure unit (an example of the electrostatic image forming means) 3, a developing device (an example of the developing means) 4Y, a first transfer roller 5Y (an example of the first transferring means), and a photoconductor cleaner (an example of the cleaning means) 6Y are disposed around the photoconductor 1Y in this order. The charging roller charges the surface of the photoconductor 1Y to a prescribed potential, and the exposure unit 3 exposes the charged surface to a laser beam 3Y according to a color-separated image signal to thereby form an electrostatic image. The developing device 4Y supplies a charged toner to the electrostatic image to develop the electrostatic image, and the first transfer roller 5Y transfers the developed toner image onto the intermediate transfer belt 20. The photoconductor cleaner 6Y removes the toner remaining on the surface of the photoconductor 1Y after the first transfer.

The first transfer roller 5Y is disposed on the inner side of the intermediate transfer belt 20 and placed at a position opposed to the photoconductor 1Y. Bias power sources (not shown) for applying a first transfer bias are connected to the respective first transfer rollers 5Y, 5M, 5C, and 5K. The bias power sources are controlled by an unillustrated controller to change the transfer biases applied to the respective first transfer rollers.

A yellow image formation operation in the first unit 10Y will be described.

First, before the operation, the surface of the photoconductor 1Y is charged by the charging roller 2Y to a potential of −600 V to −800 V.

The photoconductor 1Y is formed by stacking a photosensitive layer on a conductive substrate (with a volume resistivity of, for example, 1×10⁻⁶ Ωcm or less at 20° C.). The photosensitive layer generally has a high resistance (the resistance of a general resin) but has the property that, when irradiated with a laser beam 3Y, the specific resistance of a portion irradiated with the laser beam is changed. Therefore, the laser beam 3Y is outputted from the exposure unit 3 toward the charged surface of the photoconductor 1Y according to yellow image data sent from an unillustrated controller. The photosensitive layer of the photoconductor 1Y is irradiated with the laser beam 3Y, and an electrostatic image with a yellow image pattern is thereby formed on the surface of the photoconductor 1Y.

The electrostatic image is an image formed on the surface of the photoconductor 1Y by charging and is a negative latent image formed as follows. The specific resistance of the irradiated portions of the photosensitive layer irradiated with the laser beam 3Y decreases, and this causes charges on the surface of the photoconductor 1Y to flow. However, the charges in portions not irradiated with the laser beam 3Y remain present, and the electrostatic image is thereby formed.

The electrostatic image formed on the photoconductor 1Y rotates to a prescribed developing position as the photoconductor 1Y rotates. Then the electrostatic image on the photoconductor 1Y at the developing position is converted to a visible image (developed image) as a toner image by the developing device 4Y.

An electrostatic image developer containing, for example, at least a yellow toner and a carrier is contained in the developing device 4Y. The yellow toner is agitated in the developing device 4Y and thereby frictionally charged. The charged yellow toner has a charge with the same polarity (negative polarity) as the charge on the photoconductor 1Y and is held on a developer roller (an example of a developer holding member). As the surface of the photoconductor 1Y passes through the developing device 4Y, the yellow toner electrostatically adheres to charge-eliminated latent image portions on the surface of the photoconductor 1Y, and the latent image is thereby developed with the yellow toner. Then the photoconductor 1Y with the yellow toner image formed thereon continues running at a prescribed speed, and the toner image developed on the photoconductor 1Y is transported to a prescribed first transfer position.

When the yellow toner image on the photoconductor 1Y is transported to the first transfer position, a first transfer bias is applied to the first transfer roller 5Y, and an electrostatic force directed from the photoconductor 1Y toward the first transfer roller 5Y acts on the toner image, so that the toner image on the photoconductor 1Y is transferred onto the intermediate transfer belt 20. The transfer bias applied in this case has a (+) polarity opposite to the (−) polarity of the toner and is controlled to +10 μA in, for example, the first unit 10Y by the controller (not shown).

The toner remaining on the photoconductor 1Y is removed and collected by the photoconductor cleaner 6Y.

The first transfer biases applied to the first transfer rollers 5M, 5C, and 5K of the second unit 10M and subsequent units are controlled in the same manner as in the first unit.

The intermediate transfer belt 20 with the yellow toner image transferred thereon in the first unit 10Y is sequentially transported through the second to fourth units 10M, 10C and 10K, and toner images of respective colors are superimposed and multi-transferred.

Then the intermediate transfer belt 20 with the four color toner images multi-transferred thereon in the first to fourth units reaches a secondary transfer unit that is composed of the intermediate transfer belt 20, the support roller 24 in contact with the inner surface of the intermediate transfer belt, and a secondary transfer roller (an example of the second transferring means) 26 disposed on the image holding surface side of the intermediate transfer belt 20. A recording paper sheet (an example of the recording medium) P is supplied to a gap between the secondary transfer roller 26 and the intermediate transfer belt 20 in contact with each other at a prescribed timing through a supply mechanism, and a secondary transfer bias is applied to the support roller 24. The transfer bias applied in this case has the same polarity (−) as the polarity (−) of the toner, and an electrostatic force directed from the intermediate transfer belt 20 toward the recording paper sheet P acts on the toner image, so that the toner image on the intermediate transfer belt 20 is transferred onto the recording paper sheet P. In this case, the secondary transfer bias is determined according to a resistance detected by resistance detection means (not shown) for detecting the resistance of the secondary transfer portion and is voltage-controlled.

Then the recording paper sheet P is transported to a press contact portion (nip portion) of a pair of fixing rollers in a fixing device (an example of the fixing means) 28, and the toner image is fixed onto the recording paper sheet P to thereby form a fixed image.

Examples of the recording paper sheet P onto which a toner image is to be transferred include plain paper sheets used for electrophotographic copying machines, printers, etc. Examples of the recording medium include, in addition to the recording paper sheets P, transparencies.

To further improve the smoothness of the surface of a fixed image, it may be necessary that the surface of the recording paper sheet P be smooth. For example, coated paper prepared by coating the surface of plain paper with, for example, a resin, art paper for printing, etc. are suitably used.

The recording paper sheet P with the color image fixed thereon is transported to an ejection unit, and a series of the color image formation operations is thereby completed.

### <Process Cartridge/Toner Cartridge>

A process cartridge according to an exemplary embodiment will be described.

The process cartridge according to the present exemplary embodiment includes developing means that contains the electrostatic image developer according to the preceding exemplary embodiment and develops an electrostatic image formed on the surface of the image holding member with the electrostatic image developer to thereby form a toner image. The process cartridge is detachably attached to the image forming apparatus.

The structure of the process cartridge in the present exemplary embodiment is not limited to the above described structure. The process cartridge may include, in addition to the developing unit, at least one optional unit selected from other means such as an image holding member, charging means, electrostatic image forming means, and transferring means.

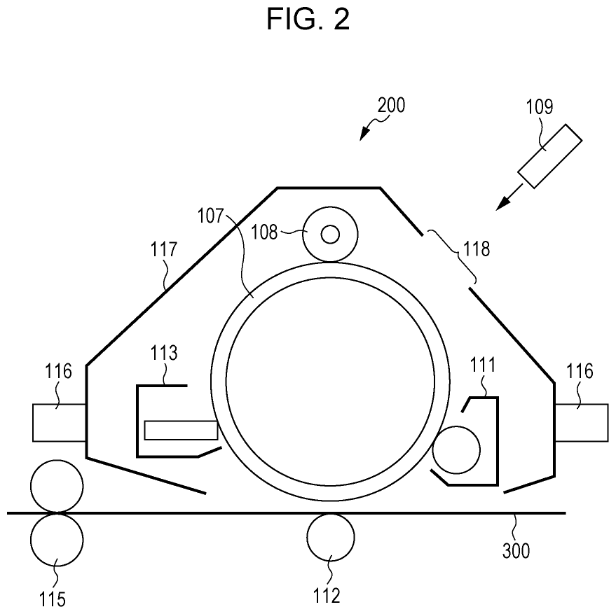

An example of the process cartridge according to the present exemplary embodiment will be described, but this is not a limitation. Major components shown in FIG. 2 will be described, and description of other components will be omitted.

FIG. 2 is a schematic configuration diagram showing the process cartridge according to the present exemplary embodiment.

The process cartridge 200 shown in FIG. 2 includes, for example, a housing 117 including mounting rails 116 and an opening 118 for light exposure and further includes a photoconductor 107 (an example of the image holding member), a charging roller 108 (an example of the charging means) disposed on the circumferential surface of the photoconductor 107, a developing device 111 (an example of the developing means), and a photoconductor cleaner 113 (an example of the cleaning means), which are integrally combined to thereby form a cartridge.

In FIG. 2, 109 denotes an exposure unit (an example of the electrostatic image forming means), and 112 denotes a transferring device (an example of the transferring means). 115 denotes a fixing device (an example of the fixing means), and 300 denotes a recording paper sheet (an example of the recording medium).

Next, a toner cartridge according to an exemplary embodiment will be described.

The toner cartridge according to the present exemplary embodiment contains the toner according to the preceding exemplary embodiment and is detachably attached to an image forming apparatus. The toner cartridge contains a replenishment toner to be supplied to the developing means disposed in the image forming apparatus.

The image forming apparatus shown in FIG. 1 has a structure in which the toner cartridges 8Y, 8M, 8C, and 8K are detachably attached, and the developing devices 4Y, 4M, 4C, and 4K are connected to the respective developing devices (corresponding to the respective colors) through unillustrated toner supply tubes. When the amount of the toner contained in a toner cartridge is reduced, this toner cartridge is replaced.

### Examples

Examples of the present disclosure will next be described. However, the present disclosure is not limited to these Examples. In the following description, “parts” and “%” are based on mass, unless otherwise specified.

### <Preparation of Dispersions>

### (Preparation of Amorphous Polyester Resin Particle Dispersion (A1))

Terephthalic acid: 30 parts by mole
Fumaric acid: 70 parts by mole
Ethylene oxide adduct of bisphenol A: 10 parts by mole
Propylene oxide adduct of bisphenol A: 90 parts by mole

The above materials are placed in a 5 L flask equipped with a stirrer, a nitrogen introduction tube, a temperature sensor, and a rectifying column. The temperature of the mixture is increased to 220° C. over 1 hour, and titanium tetraethoxide is added in an amount of 1 part with respect to 100 parts of the above materials. While water produced is removed by evaporation, the temperature is increased to 230° C. over 0.5 hours. A dehydration condensation reaction is continued at 230° C. for 1 hour, and the reaction product is cooled. An amorphous polyester resin (A1) having a weight average molecular weight of 20,000, an acid value of 13 mgKOH/g, and a glass transition temperature of 60° C. is thereby synthesized.

Next, a container equipped with temperature controlling means and nitrogen purging means is charged with 40 parts of ethyl acetate and 25 parts of 2-butanol to prepare a solvent mixture, and 100 parts of the amorphous polyester resin (A1) is gradually added to the solvent mixture and dissolved therein. Then a 10 mass % aqueous ammonia solution is added thereto (in a molar amount corresponding to three times the acid value of the resin), and the mixture is stirred for 30 minutes.

Next, the container is purged with dry nitrogen, and the temperature is held at 40° C. While the solution mixture is stirred, 400 parts of ion exchanged water is added dropwise at a rate of 2 parts/minute to emulsify the mixture. After completion of the dropwise addition, the temperature of the emulsion is returned to room temperature (20° C. to 25° C.), and dry nitrogen is bubbled into the emulsion for 48 hours under stirring to reduce the contents of ethyl acetate and 2-butanol to 1,000 ppm or less. A resin particle dispersion in which resin particles having a volume average particle diameter of 200 nm are dispersed is thereby obtained. Ion exchanged water is added to the resin particle dispersion to adjust the solid content to 20% by mass, and an amorphous polyester resin dispersion (A1) is thereby obtained.

### (Preparation of Amorphous Polyester Resin Particle Dispersion (A2))

An amorphous polyester resin particle dispersion (A2) is obtained using the same procedure as in the preparation of the amorphous polyester resin particle dispersion (A1) except that the temperature is increased to 220° C. over 0.5 hours while water produced is removed and that the dehydration condensation reaction is continued at 220° C. for 1 hour.

The amorphous polyester resin (A2) obtained has a weight average molecular weight of 16,000, an acid value of 15.5 mgKOH/g, and a glass transition temperature of 58° C.

### (Preparation of Amorphous Polyester Resin Particle Dispersion (A3))

An amorphous polyester resin particle dispersion (A3) is obtained using the same procedure as in the preparation of the amorphous polyester resin particle dispersion (A1) except that the temperature is increased to 210° C. over 0.5 hours while water produced is removed and that the dehydration condensation reaction is continued at 210° C. for 1 hour.

The amorphous polyester resin (A3) obtained has a weight average molecular weight of 18,000, an acid value of 15 mgKOH/g, and a glass transition temperature of 59° C.

### (Preparation of Amorphous Polyester Resin Particle Dispersion (A4))

An amorphous polyester resin particle dispersion (A4) is obtained using the same procedure as in the preparation of the amorphous polyester resin particle dispersion (A1) except that the temperature is increased to 230° C. over 0.5 hours while water produced is removed and that the dehydration condensation reaction is continued at 230° C. for 1.5 hours.

The amorphous polyester resin (A4) obtained has a weight average molecular weight of 22,000, an acid value of 9 mgKOH/g, and a glass transition temperature of 62° C.

### (Preparation of Amorphous Polyester Resin Particle Dispersion (A5))

An amorphous polyester resin particle dispersion (A5) is obtained using the same procedure as in the preparation of the amorphous polyester resin particle dispersion (A1) except that the temperature is increased to 230° C. over 0.5 hours while water produced is removed and that the dehydration condensation reaction is continued at 230° C. for 2 hours.

The amorphous polyester resin (A5) obtained has a weight average molecular weight of 24,000, an acid value of 8.5 mgKOH/g, and a glass transition temperature of 63° C.

### (Preparation of Crystalline Polyester Resin Particle Dispersion (A1))

1,10-Dodecanedioic acid: 50 parts by mole
1,9-Nonanediol: 50 parts by mole

The above monomer components are placed in a reaction vessel equipped with a stirrer, a thermometer, a condenser, and a nitrogen gas introduction tube, and the reaction vessel is purged with dry nitrogen gas. Then titanium tetrabutoxide (reagent) is added in an amount of 0.25 parts with respect to 100 parts of the monomer components. The mixture is allowed to react at 170° C. in a nitrogen gas flow for 3 hours. The resulting mixture is further heated to 210° C. over 1 hour, and the pressure inside the reaction vessel is reduced to 3 kPa. Then the mixture is allowed to react under the reduced pressure for 13 hours while stirred, and a crystalline polyester resin (A1) is thereby obtained.

The crystalline polyester resin (A1) obtained has a melting temperature Tm of 73.6° C. as measured by DSC, a mass average molecular weight Mw of 25,000 as measured by GPC, a number average molecular weight Mn of 10,500 as measured by GPC, and an acid value AV of 10.1 mgKOH/g.

Next, a jacketed 3 L reaction tank (BJ-30N manufactured by TOKYO RIKAKIKAI Co., Ltd.) equipping with a condenser, a thermometer, a water dropping unit, and an anchor blade is charged with 300 parts of the crystalline polyester resin (A1), 160 parts of methyl ethyl ketone (solvent), and 100 parts of isopropyl alcohol (solvent), and the mixture is stirred at 100 rpm while the temperature of the mixture is maintained at 70° C. in a water-circulation thermostatic bath to thereby dissolve the resin (a solution preparing step).

Then the number of revolutions for stirring is changed to 150 rpm, and the temperature of the water-circulation thermostatic bath is set to 66° C. Then 17 parts of 10% ammonia water (reagent) is added over 10 minutes, and a total of 900 parts of ion exchanged water held at 66° C. is added dropwise at a rate of 7 parts/minute to perform phase inversion to thereby obtain an emulsion.

Immediately after the emulsification, 800 parts of the obtained emulsion and 700 parts of ion exchanged water are placed in a 2 L round bottom flask, and the round bottom flask is placed in an evaporator (TOKYO RIKAKIKAI Co., Ltd.) equipped with a vacuum control unit through a trap ball. While rotated, the round bottom flask is heated in a hot water bath at 60° C., and the pressure inside the flask is reduced to 7 kPa with attention to bumping to remove the solvent. When the amount of the solvent collected has reached 1,100 parts, the pressure is returned to normal pressure, and the round bottom flask is water-cooled to thereby obtain a dispersion. The obtained dispersion has no solvent odor. The resin particles in the dispersion have a volume average particle diameter D50v of 130 nm. Then ion exchanged water is added to adjust the solid concentration to 20%, and the resulting dispersion is used as a crystalline polyester resin particle dispersion (A1).

### (Preparation of Coloring Agent Dispersion (A1))

Basic dye: azo-based dye (Basic Red 36 manufactured by Nippon Kasei Chemical Co., Ltd.): 70 parts
Anionic surfactant (Neogen RK manufactured by DAI-ICHI KOGYO SEIYAKU Co., Ltd.): 30 parts
Ion exchanged water: 200 parts

The above materials are mixed and dispersed for 10 minutes using a homogenizer (ULTRA-TURRAX T50 manufactured by IKA). Ion exchanged water is added such that the content of the basic dye in the dispersion is 20% by mass, and a coloring agent dispersion (A1) with the basic dye dispersed therein is thereby obtained.

### (Preparation of Coloring Agent Dispersion (A2))

Basic dye: rhodamine B (Basic Violet 10 manufactured by Nippon Kasei Chemical Co., Ltd.): 70 parts
Anionic surfactant (Neogen RK manufactured by DAI-ICHI KOGYO SEIYAKU Co., Ltd.): 30 parts
Ion exchanged water: 200 parts.

The above materials are mixed and dispersed for 10 minutes using a homogenizer (ULTRA-TURRAX T50 manufactured by IKA). Ion exchanged water is added such that the content of the basic dye in the dispersion is 20% by mass, and a coloring agent dispersion (A2) with the basic dye dispersed therein is thereby obtained.

### (Preparation of Coloring Agent Dispersion (A3))

Acidic dye: azo-based dye (Acid Yellow 23 manufactured by Nippon Kasei Chemical Co., Ltd.): 70 parts
Anionic surfactant (Neogen RK manufactured by DAI-ICHI KOGYO SEIYAKU Co., Ltd.): 30 parts
Ion exchanged water: 200 parts

The above materials are mixed and dispersed for 10 minutes using a homogenizer (ULTRA-TURRAX T50 manufactured by IKA). Ion exchange water is added such that the content of the acidic dye in the dispersion is 20% by mass, and a coloring agent dispersion (A3) with the acidic dye dispersed therein is thereby obtained.

### (Preparation of Coloring Agent Dispersion (A4))

Basic dye: azo-based dye (Basic Yellow 24 manufactured by Alpha Chemical): 70 parts
Anionic surfactant (Neogen RK manufactured by DAI-ICHI KOGYO SEIYAKU Co., Ltd.): 30 parts
Ion exchanged water: 200 parts

The above materials are mixed and dispersed for 10 minutes using a homogenizer (ULTRA-TURRAX T50 manufactured by IKA). Ion exchanged water is added such that the content of the basic dye in the dispersion is 20% by mass, and a coloring agent dispersion (A4) with the basic dye dispersed therein is thereby obtained.

### (Preparation of Coloring Agent Dispersion (A5))

Basic dye: thiazole-based dye (Basic Yellow 1 manufactured by TOKYO CHEMICAL INDUSTRY Co., Ltd.): 70 parts
Anionic surfactant (Neogen RK manufactured by DAI-ICHI KOGYO SEIYAKU Co., Ltd.): 30 parts
Ion exchanged water: 200 parts

The above materials are mixed and dispersed for 10 minutes using a homogenizer (ULTRA-TURRAX T50 manufactured by IKA). Ion exchanged water is added such that the content of the basic dye in the dispersion is 20% by mass, and a coloring agent dispersion (A5) with the basic dye dispersed therein is thereby obtained.

### (Preparation of Release Agent Particle Dispersion (A1))

Paraffin wax (HNP-9 manufactured by Nippon Seiro Co., Ltd.): 100 parts
Anionic surfactant (Neogen RK manufactured by DAI-ICHI KOGYO SEIYAKU Co., Ltd.): 1 part
Ion exchanged water: 350 parts

The above materials are mixed, heated to 100° C., dispersed using a homogenizer (ULTRA-TURRAX T50 manufactured by IKA), and subjected to dispersion treatment using a Manton-Gaulin high-pressure homogenizer (manufactured by Gaulin Corporation) to thereby obtain a release agent particle dispersion (A1) (solid content: 20% by mass) containing dispersed therein release agent particles with a volume average particle diameter of 200 nm.

### (Preparation of Release Agent Particle Dispersion (A2))

Carnauba wax (RC-160 manufactured by TOA KASEI CO., LTD.): 100 parts
Anionic surfactant (NEOGEN RK manufactured by DAI-ICHI KOGYO SEIYAKU Co., Ltd.): 1 part
Ion exchanged water: 350 parts

The above materials are mixed, heated to 100° C., dispersed using a homogenizer (ULTRA-TURRAX T50 manufactured by IKA), and subjected to dispersion treatment using a Manton-Gaulin high-pressure homogenizer (manufactured by Gaulin Corporation) to thereby obtain a release agent particle dispersion (A2) (solid content: 20% by mass) containing dispersed therein release agent particles with a volume average particle diameter of 200 nm.

### (Preparation of Release Agent Particle Dispersion (A3))

Polyethylene wax (SANWAX E-310 manufactured by Sanyo Chemical Industries, Ltd.): 100 parts
Anionic surfactant (NEOGEN RK manufactured by DAI-ICHI KOGYO SEIYAKU Co., Ltd.): 1 part
Ion exchanged water: 350 parts

The above materials are mixed, heated to 100° C., dispersed using a homogenizer (ULTRA-TURRAX T50 manufactured by IKA), and subjected to dispersion treatment using a Manton-Gaulin high-pressure homogenizer (manufactured by Gaulin Corporation) to thereby obtain a release agent particle dispersion (A3) (solid content: 20% by mass) containing dispersed therein release agent particles with a volume average particle diameter of 200 nm.

### <Preparation of Toner Particles (A1)>

### —First Aggregated Particle Forming Step—

Amorphous polyester resin particle dispersion (A1): 425 parts
Crystalline polyester resin particle dispersion (A1): 32 parts
Coloring agent dispersion (A1): 20 parts
Anionic surfactant (TaycaPower manufactured by Tayca Corporation): 30 parts
Release agent particle dispersion (A1): 35 parts

The above materials are placed in a stainless steel round flask. Then 0.1N nitric acid is added to adjust the pH to 3.5, and 30 parts of an aqueous nitric acid solution with a poly-aluminum chloride concentration of 10% by mass is added. Then a homogenizer (ULTRA-TURRAX T50 manufactured by IKA) is used to disperse the particles, and the temperature of the resulting dispersion (R) is adjusted to 25° C. The dispersion (R) is heated to a temperature range of 47 to 49° C. in a heating oil bath.

### —Second Aggregated Particle Forming Step—

While the temperature of the dispersion (R) is maintained in the temperature range of 47° C. to 49° C., 25 parts of the amorphous polyester resin particle dispersion (A1) and 25 parts of the crystalline polyester resin particle dispersion (A1) that are used as the second resin particles and 15 parts of the release agent particle dispersion (A1) are added and aggregated at a temperature of 47° C. to 49° C.

### —Third Aggregated Particles Forming Step—

Then 50 parts of the amorphous polyester resin particle dispersion (A1) used as the third resin particles is added, and the mixture is held for 1 hour. Then a 0.1N aqueous sodium hydroxide solution is added to adjust the pH to 8.5.

### —Fusion/Coalescence Step—

The mixture is heated to 100° C. under continuous stirring and held for 10 hours. Next, the mixture is cooled to room temperature. The mixture is filtered, washed sufficiently with ion exchanged water, and dried to thereby obtain toner particles with a volume average particle diameter of 6.0 μm. The obtained toner particles are used as toner particles (A1).

### <Production of Toner Particles (A2) to (A23), (A25) to (A33), and (AC1) to (AC8)>

Toner particles are obtained using the same procedure as that for the toner particles (A1) except that the type of amorphous polyester resin particle dispersion, the type of coloring agent dispersion used, the type of release agent particle dispersion, the amount of the release agent particle dispersion used in the first aggregated particle forming step, the amount of the release agent particle dispersion used in the second aggregated particle forming step, and the temperature of the dispersion (R) when the release agent particle dispersion is added are changed as shown in Tables 1-1 to 2-2.

### <Production of Toner Particles (A24)>

### (Synthesis of Crystalline Polyester Resin (A24))

A 5 L flask equipped with a stirrer, a nitrogen introduction tube, a temperature sensor, and a rectifying column is charged with 80.9 parts of fumaric acid and 46.3 parts of 1,10-decanediol, and then titanium tetraethoxide is added in an amount of 1 part with respect to 100 parts of the above materials (fumaric acid and 1,10-decanediol). While water produced is removed, a reaction is allowed to proceed at 150° C. for 4 hours. Then the temperature is increased to 180° C. in a nitrogen flow over 6 hours, and the reaction is allowed to proceed at 180° C. for 6 hours. Then the reaction is allowed to proceed for 1 hour under reduced pressure, and the product is cooled to thereby obtain an unmodified crystalline polyester resin (A24).

### (Synthesis of Amorphous Polyester Resin (A24)

A 5 L flask equipped with a stirrer, a nitrogen introduction tube, a temperature sensor, and a rectifying column is charged with 30 parts of isophthalic acid, 70 parts of fumaric acid, 5 parts by mole of ethylene oxide adduct of bisphenol A, and 95 parts of propylene oxide adduct of bisphenol A, and the temperature of the mixture is increased to 220° C. over 1 hour. Then titanium tetraethoxide is added in an amount of 1 part with respect to 100 parts of the above materials (isophthalic acid, fumaric acid, ethylene oxide adduct of bisphenol A, and propylene oxide adduct of bisphenol A). While water produced is removed by evaporation, the temperature is increased to 230° C. over 0.5 hours. A dehydration condensation reaction is continued at 230° C. for 1 hour, and the reaction product is cooled. Then isophorone diisocyanate is added in an amount of 2 parts with respect to 1 part of the resin, and 5 parts of ethyl acetate is added to dissolve the resin. Then a reaction is allowed to proceed at 200° C. for 3 hours, and the reaction product was cooled to thereby obtain an amorphous polyester resin (A24) having a terminal isocyanate group.

### (Preparation of Release Agent Particle Dispersion)

100 Parts of paraffin wax (HNP-9 manufactured by Nippon Seiro Co., Ltd.), 1 part of an anionic surfactant (Neogen RK manufactured by DAI-ICHI KOGYO SEIYAKU Co., Ltd.), and 350 parts of ion exchanged water are mixed, heated to 100° C., dispersed using a homogenizer (ULTRA-TURRAX T50 manufactured by IKA), and subjected to dispersion treatment using a Manton-Gaulin high-pressure homogenizer (manufactured by Gaulin Corporation) to thereby obtain a release agent particle dispersion (solid content: 20% by mass) containing dispersed therein release agent particles with a volume average particle diameter of 200 nm.

### (Production of Master Batch)

150 Parts of the amorphous polyester resin (A24), 3 parts of a basic dye rhodamine B (Basic Violet 10 manufactured by Nippon Kasei Chemical Co., Ltd.), and 20 parts of ion exchanged water are mixed using a Henschel mixer. The mixture obtained is pulverized to produce a master batch.

### (Production of Oil Phase (A)/Water Phase)

107 Parts of the amorphous polyester resin (A24), 75 parts of the release agent particle dispersion, 18 parts of the master batch, and 73 parts of ethyl acetate are placed in a homogenizer (ULTRA-TURRAX T50 manufactured by IKA), stirred, dissolved, and dispersed to obtain an oil phase (A). 990 Parts of ion exchanged water, 100 parts of an anionic surfactant, and 100 parts of ethyl acetate are mixed in a different flask and stirred to obtain a water phase.

### (Emulsification and Dispersion)

100 Parts of a solution prepared by dissolving the crystalline polyester resin (A24) in ethyl acetate (solid concentration: 10%) and 3 parts of isophoronediamine are added to 450 parts of the oil phase (A), and the mixture is stirred using a homogenizer (ULTRA-TURRAX T50 manufactured by IKA), dissolved, and dispersed at 50° C. to thereby obtain an oil phase (B). Next, 400 parts of the water phase is placed in an different container and stirred at 50° C. using a homogenizer (ULTRA-TURRAX T50 manufactured by IKA). 50 Parts of the oil phase (B) is added to the water phase, and the mixture is stirred at 50° C. for 5 minutes using a homogenizer (ULTRA-TURRAX T50 manufactured by IKA) to thereby obtain an emulsified slurry. The solvent in the emulsified slurry is removed at 50° C. for 15 hours to obtain a toner slurry. The toner slurry is filtered under reduced pressure and subjected to washing treatment to obtain toner particles.

Then the toner particles are washed, and a 5 L flask equipped with a stirrer, a nitrogen introduction tube, a temperature sensor, and a rectifying column is charged with a dispersion prepared by adding 50 parts of the toner particles to 500 parts of ion exchanged water. Then the dispersion is stirred and heated to 85° C. After the heating, the dispersion is stirred for 24 hours while the increased temperature is maintained. The toner particles are thereby heated at 85° C. for 24 hours. Then liquid nitrogen is added to the dispersion to cool (quench) the toner particles to room temperature (25° C.) at 20° C./minute. Then the dispersion is reheated to 55° C., held for 7 hours, and then cooled to 20° C. at a rate of 20° C./minute.

### (Drying and Sieving)

The toner particles obtained are dried and sieved to produce toner particles with a volume average particle diameter of 7 μm.

The toner particles (A24) are obtained through the above steps.

### <Production of Toner Particles (AC9)>

Toner particles (AC9) are produced by a kneading-grinding method.

Specifically, 20 parts of a crystalline polyester resin (the crystalline polyester resin synthesized when the crystalline polyester resin particle dispersion (A1) is prepared), 20 parts of a basic dye (rhodamine B: Basic Violet 10 manufactured by Nippon Kasei Chemical Co., Ltd.), and 50 parts of paraffin wax (HNP-9 manufactured by Nippon Seiro Co., Ltd.) used as the release agent are added to 40 parts of an amorphous polyester resin (the amorphous polyester resin synthesized when the amorphous polyester resin particle dispersion (A1) is prepared), and the mixture is kneaded using a pressurizing kneader. The kneaded product is coarsely pulverized to produce toner particles (AC9) having a volume average particle diameter of 6.0 μm.

### Examples 1 to 33 and Comparative Examples 1 to 9

100 Parts of one type of toner particles and 0.7 parts of silica particles treated with dimethyl silicone oil (RY200 manufactured by Nippon Aerosil Co., Ltd.) are mixed using a Henschel mixer to thereby obtain a toner in an Example or a Comparative Example.

Then 8 parts of the toner obtained and 100 parts of a carrier described below are mixed to obtain a developer in an Example or a Comparative Example.

### —Production of Carrier—

Ferrite particles (average particle diameter: 50 μm): 100 parts
Toluene: 14 parts
Styrene/methyl methacrylate copolymer (copolymerization ratio: 15/85): 3 parts
Carbon black: 0.2 parts

The above components other than the ferrite particles are dispersed using a sand mill to prepare a dispersion, and the dispersion and the ferrite particles are placed in a vacuum degassing-type kneader, and the mixture is dried under reduced pressure while stirred to thereby obtain a carrier.

### <Evaluation>

One of the developers obtained in the Examples and Comparative Examples is charged into a developing unit of an image forming apparatus “DocuCentre Color 400 manufactured by Fuji Xerox Co., Ltd.,” and this image forming apparatus is used to evaluate the following properties.

### (Evaluation of Difference in Gloss)

Imaging Society of Japan (ISJ) Test Chart No. 5-1 including solid images with an area coverage of 100% (images with a toner mass per unit area (TMA) of 3.8 g/m²) is outputted on 100 sheets of OS coated paper (product name, manufactured by FUJIFILM Business Innovation Corp.) at a process speed of 228 mm/s in an environment of a temperature of 35° C. and a humidity of 85% RH. Then a solid image with an area coverage of 100% (an image with a toner mass per unit area (TMA) of 14.4 g/m²) is outputted on 100 sheets of the OS coated paper at a fixation temperature of 190° C. and a process speed of 60 m/s.

After the ISJ Test Chart No. 5-1 has been outputted on 100 sheets of the OS coated paper, the gloss of a green portion on each sheet is measured by the following method.

The gloss is measured using a portable glossmeter (BYK Gardner micro-tri-gloss manufactured by Toyo Seiki Seisaku-sho, Ltd.). Specifically, the gloss at 60 degrees is measured at 5 points.

The difference in gloss is determined from the measured values and evaluated according to the following criteria.

A: The maximum value of the differences in gloss between the first outputted image and 2nd to 100th images is less than 2°.

B: The maximum value of the differences in gloss between the first outputted image and 2nd to 100th images is 2° or more and less than 5°.

C: The maximum value of the differences in gloss between the first outputted image and 2nd to 100th images is 5° or more.

### (Evaluation of Degree of Increase in Gloss)

The ISJ Test Chart No. 5-1 is outputted on 100 sheets of the OS coated paper under the same conditions as those for the (Evaluation of difference in gloss).

The gloss at 60 degrees of the green portion of each of the ISJ Test Chart No. 5-1 outputted on the first OS coated paper sheet and the ISJ Test Chart No. 5-1 outputted on the 100th OS coated paper sheet is measured and evaluated according to the following criteria.

The gloss is measured using a portable glossmeter (BYK Gardner micro-tri-gloss manufactured by Toyo Seiki Seisaku-sho, Ltd.).

The evaluation is performed using the following criteria.

A: The maximum difference in gloss between the first outputted image and the 100th outputted image is less than 2°.

B: The maximum difference in gloss between the first outputted image and the 100th outputted image is 2° or more and less than 5°.

C: The maximum difference in gloss between the first outputted image and the 100th outputted image is 5° or more.

TABLE 1-1

| | | | | | | | Release agent | | | | | |
|---|---|---|---|---|---|---|---|---|---|---|---|---|
| | | | | | | | | | | Temperature of | | Content |
| | | | | Crys- | | | | Amount of dispersion | | dispersion (R) when | | (%, |
| | | | | talline | | | Type | charged (parts) | | release agent is added | | with |
| | Type | Amorphous resin | | resin | Coloring agent | | of | First | Second | First | Second | respect |
| | of | Type | Acid | Type | Type of | | release | aggregated | aggregated | aggregated | aggregated | to |
| | toner | of | value | of | coloring | | agent | particle | particle | particle | particle | toner |
| | part- | dis- | (mgKOH/ | disper- | agent | Type of | dis- | forming | forming | forming | forming | par- |
| | icles | persion | g) | sion | dispersion | coloring agent | persion | step | step | step | step | ticles) |
| Example 1 | A1 | A1 | 13 | A1 | A1 | Basic dye/ | A1 | 35 | 15 | 25 | 47 | 5 |
| | | | | | | azo-based | | | | | | |
| Example 2 | A2 | A1 | 13 | A1 | A2 | Basic dye/ | A1 | 22 | 6 | 25 | 47 | 5 |
| | | | | | | rhodamine-based | | | | | | |
| Com- | AC1 | A1 | 13 | A1 | A2 | Basic dye/ | A1 | 35 | 15 | 25 | 47 | 9 |
| parative | | | | | | rhodamine-based | | | | | | |
| Example 1 | | | | | | | | | | | | |
| Example 3 | A3 | A1 | 13 | A1 | A2 | Basic dye/ | A1 | 35 | 15 | 25 | 47 | 9 |
| | | | | | | rhodamine-based | | | | | | |
| Com- | AC2 | A1 | 13 | A1 | A2 | Basic dye/ | A1 | 35 | 15 | 25 | 47 | 9 |
| parative | | | | | | rhodamine-based | | | | | | |
| Example 2 | | | | | | | | | | | | |
| Example 4 | A4 | A1 | 13 | A1 | A2 | Basic dye/ | A1 | 35 | 15 | 25 | 47 | 9 |
| | | | | | | rhodamine-based | | | | | | |
| Example 5 | A5 | A1 | 13 | A1 | A2 | Basic dye/ | A1 | 35 | 15 | 25 | 47 | 9 |
| | | | | | | rhodamine-based | | | | | | |
| Example 6 | A6 | A1 | 13 | A1 | A2 | Basic dye/ | A1 | 35 | 15 | 25 | 47 | 9 |
| | | | | | | rhodamine-based | | | | | | |
| Example 7 | A7 | A1 | 13 | A1 | A2 | Basic dye/ | A1 | 35 | 15 | 25 | 47 | 9 |
| | | | | | | rhodamine-based | | | | | | |
| Example 8 | A8 | A1 | 13 | A1 | A2 | Basic dye/ | A1 | 35 | 15 | 25 | 47 | 9 |
| | | | | | | rhodamine-based | | | | | | |
| Example 9 | A9 | A1 | 13 | A1 | A2 | Basic dye/ | A1 | 35 | 15 | 25 | 47 | 9 |
| | | | | | | rhodamine-based | | | | | | |
| Example 10 | A10 | A1 | 13 | A1 | A2 | Basic dye/ | A1 | 35 | 15 | 25 | 47 | 9 |
| | | | | | | rhodamine-based | | | | | | |
| Example 11 | A1l | A1 | 13 | A1 | A2 | Basic dye/ | A1 | 35 | 15 | 25 | 47 | 9 |
| | | | | | | rhodamine-based | | | | | | |
| Example 12 | A12 | A1 | 13 | A1 | A2 | Basic dye/ | A1 | 48 | 14 | 25 | 47 | 11 |
| | | | | | | rhodamine-based | | | | | | |
| Example 13 | A13 | A1 | 13 | A1 | A2 | Basic dye/ | A1 | 43 | 12 | 25 | 47 | 10 |
| | | | | | | rhodamine-based | | | | | | |
| Example 14 | A14 | A1 | 13 | A1 | A2 | Basic dye/ | A1 | 17 | 5 | 25 | 47 | 4 |
| | | | | | | rhodamine-based | | | | | | |
| Example 15 | A15 | A1 | 13 | A1 | A3 | Acidic dye/ | A1 | 35 | 15 | 25 | 47 | 9 |
| | | | | | | azo-based | | | | | | |
| Example 16 | A16 | A1 | 13 | A1 | A4 | Basic dye/ | A1 | 35 | 15 | 25 | 47 | 9 |
| | | | | | | azo-based | | | | | | |
| Example 17 | A17 | A1 | 13 | A1 | A5 | Basic dye/ | A1 | 35 | 15 | 25 | 47 | 9 |
| | | | | | | thiazole-based | | | | | | |

TABLE 1-2

| | Cross sectional observation | | | | | | | | Evaluation | |
|---|---|---|---|---|---|---|---|---|---|---|
| | Presence ratio | Presence ratio in | | | | | | XPS | | Degree |
| | in regions | regions 2 μm or | | | | | | (Lub/ | | of |
| | within 400 | more (%, with respect | | | | W1/ | W2/ | Res) × | Difference | increase |
| | nm (%) | to binder resin) | W1 | W2 | W3 | W2 | W3 | 100 | in gloss | in gloss |
| Example 1 | 25 | 0.8 | 8 | 4 | 0.9 | 2 | 4.5 | 11 | B | A |
| Example 2 | 26 | 0.8 | 8 | 4 | 0.9 | 2 | 4.5 | 11 | B | A |
| Comparative | 24 | 1.1 | 5.5 | 4 | 0.9 | 1.375 | 4.5 | 9 | C | A |
| Example 1 | | | | | | | | | | |
| Example 3 | 50 | 0.8 | 8 | 4 | 0.9 | 2 | 4.5 | 11 | A | B |
| Comparative | 51 | 1.1 | 5.5 | 4 | 0.9 | 1.38 | 4.5 | 9 | C | B |
| Example 2 | | | | | | | | | | |
| Example 4 | 46 | 0.8 | 8 | 4 | 0.9 | 2 | 4.5 | 11 | B | A |
| Example 5 | 45 | 0.8 | 8 | 4 | 0.9 | 2 | 4.5 | 11 | B | A |
| Example 6 | 30 | 0.8 | 8 | 4 | 0.9 | 2 | 4.5 | 11 | B | B |
| Example 7 | 29 | 0.8 | 8 | 4 | 0.9 | 2 | 4.5 | 11 | B | B |
| Example 8 | 41 | 0.8 | 8 | 4 | 0.9 | 2 | 4.5 | 11 | B | A |
| Example 9 | 40 | 0.8 | 8 | 4 | 0.9 | 2 | 4.5 | 11 | A | A |
| Example 10 | 35 | 0.8 | 8 | 4 | 0.9 | 2 | 4.5 | 11 | A | A |
| Example 11 | 34 | 0.8 | 8 | 4 | 0.9 | 2 | 4.5 | 11 | B | A |
| Example 12 | 37 | 0.8 | 8 | 4 | 0.9 | 2 | 4.5 | 11 | B | A |
| Example 13 | 37 | 0.8 | 8 | 4 | 0.9 | 2 | 4.5 | 11 | A | A |
| Example 14 | 37 | 0.8 | 8 | 4 | 0.9 | 2 | 4.5 | 11 | B | B |
| Example 15 | 37 | 0.8 | 8 | 4 | 0.9 | 2 | 4.5 | 11 | B | B |
| Example 16 | 37 | 0.8 | 8 | 4 | 0.9 | 2 | 4.5 | 11 | B | B |
| Example 17 | 37 | 0.8 | 8 | 4 | 0.9 | 2 | 4.5 | 11 | B | B |

TABLE 2-1

| | | | | | | | Release agent | | | | | |
|---|---|---|---|---|---|---|---|---|---|---|---|---|
| | | | | | | | | | | Temperature of | | Content |
| | | | | Crys- | | | | Amount of dispersion | | dispersion (R) when | | (%, |
| | | | | talline | | | Type | charged (parts) | | release agent is added | | with |
| | Type | Amorphous resin | | resin | Coloring agent | | of | First | Second | First | Second | respect |
| | of | Type | Acid | Type | Type of | | release | aggregated | aggregated | aggregated | aggregated | to |
| | toner | of | value | of | coloring | | agent | particle | particle | particle | particle | toner |
| | par- | disper- | (mgKOH/ | disper- | agent | Type of | dis- | forming | forming | forming | forming | par- |
| | ticles | sion | g) | sion | dispersion | coloring agent | persion | step | step | step | step | ticles) |
| Example 18 | A18 | A2 | 15.5 | A1 | A2 | Basic dye/ | A1 | 35 | 15 | 25 | 47 | 9 |
| | | | | | | rhodamine-based | | | | | | |
| Example 19 | A19 | A3 | 15 | A1 | A2 | Basic dye/ | A1 | 35 | 15 | 25 | 47 | 9 |
| | | | | | | rhodamine-based | | | | | | |
| Example 20 | A20 | A4 | 9 | A1 | A2 | Basic dye/ | A1 | 35 | 15 | 25 | 47 | 9 |
| | | | | | | rhodamine-based | | | | | | |
| Example 21 | A21 | A5 | 8.5 | A1 | A2 | Basic dye/ | A1 | 35 | 15 | 25 | 47 | 9 |
| | | | | | | rhodamine-based | | | | | | |
| Example 22 | A22 | A1 | 13 | A1 | A2 | Basic dye/ | A2 | 35 | 15 | 25 | 47 | 9 |
| | | | | | | rhodamine-based | | | | | | |
| Example 23 | A23 | A1 | 13 | A1 | A2 | Basic dye/ | A3 | 35 | 15 | 25 | 47 | 9 |
| | | | | | | rhodamine-based | | | | | | |
| Example 24 | A24 | — | 13 | — | — | Basic dye/ | — | — | — | — | — | 9 |
| | | | | | | rhodamine-based | | | | | | |
| Example 25 | A25 | A1 | 13 | A1 | A2 | Basic dye/ | A1 | 35 | 15 | 25 | 47 | 9 |
| | | | | | | rhodamine-based | | | | | | |
| Com- | AC3 | A1 | 13 | A1 | A2 | Basic dye/ | A1 | 35 | 15 | 25 | 47 | 9 |
| parative | | | | | | rhodamine-based | | | | | | |
| Example 3 | | | | | | | | | | | | |
| Example 26 | A26 | A1 | 13 | A1 | A2 | Basic dye/ | A1 | 35 | 15 | 25 | 47 | 9 |
| | | | | | | rhodamine-based | | | | | | |
| Com- | AC4 | A1 | 13 | A1 | A2 | Basic dye/ | A1 | 35 | 15 | 25 | 47 | 9 |
| parative | | | | | | rhodamine-based | | | | | | |
| Example 4 | | | | | | | | | | | | |
| Example 27 | A27 | A1 | 13 | A1 | A2 | Basic dye/ | A1 | 35 | 15 | 25 | 47 | 9 |
| | | | | | | rhodamine-based | | | | | | |
| Com- | AC5 | A1 | 13 | A1 | A2 | Basic dye/ | A1 | 35 | 15 | 25 | 47 | 9 |
| parative | | | | | | rhodamine-based | | | | | | |
| Example 5 | | | | | | | | | | | | |
| Example 28 | A28 | A1 | 13 | A1 | A2 | Basic dye/ | A1 | 35 | 15 | 25 | 47 | 9 |
| | | | | | | rhodamine-based | | | | | | |
| Com- | AC6 | A1 | 13 | A1 | A2 | Basic dye/ | A1 | 35 | 15 | 25 | 47 | 9 |
| parative | | | | | | rhodamine-based | | | | | | |
| Example 6 | | | | | | | | | | | | |
| Example 29 | A29 | A1 | 13 | A1 | A2 | Basic dye/ | A1 | 30 | 9 | 25 | 45 | 7 |
| | | | | | | rhodamine-based | | | | | | |
| Example 30 | A30 | A1 | 13 | A1 | A2 | Basic dye/ | A1 | 17 | 5 | 25 | 47 | 4 |
| | | | | | | rhodamine-based | | | | | | |
| Example 31 | A31 | A1 | 13 | A1 | A2 | Basic dye/ | A1 | 48 | 14 | 25 | 49 | 11 |
| | | | | | | rhodamine-based | | | | | | |
| Example 32 | A32 | A1 | 13 | A1 | A2 | Basic dye/ | A1 | 22 | 6 | 25 | 47 | 5 |
| | | | | | | rhodamine-based | | | | | | |
| Example 33 | A33 | A1 | 13 | A1 | A2 | Basic dye/ | A1 | 30 | 9 | 25 | 47 | 7 |
| | | | | | | rhodamine-based | | | | | | |
| Com- | AC7 | A1 | 13 | A1 | A2 | Basic dye/ | A1 | 30 | 9 | 25 | 25 | 7 |
| parative | | | | | | rhodamine-based | | | | | | |
| Example 7 | | | | | | | | | | | | |
| Com- | AC8 | A1 | 13 | A1 | A2 | Basic dye/ | A1 | 30 | 9 | 25 | 40 | 7 |
| parative | | | | | | rhodamine-based | | | | | | |
| Example 8 | | | | | | | | | | | | |
| Com- | AC9 | — | 13 | — | A2 | Basic dye/ | — | — | — | — | — | 7 |
| parative | | | | | | rhodamine-based | | | | | | |
| Example 9 | | | | | | | | | | | | |

TABLE 2-2

| | Cross sectional observation | | | | | | | | Evaluation | |
|---|---|---|---|---|---|---|---|---|---|---|
| | Presence ratio | Presence ratio in | | | | | | XPS | | Degree |
| | in regions | regions 2 μm or | | | | | | (Lub/ | | of |
| | within 400 | more (%, with respect | | | | W1/ | W2/ | Res) × | Difference | increase |
| | nm (%) | to binder resin) | W1 | W2 | W3 | W2 | W3 | 100 | in gloss | in gloss |
| Example 18 | 37 | 0.8 | 8 | 4 | 0.9 | 2 | 4.5 | 11 | B | B |
| Example 19 | 37 | 0.8 | 8 | 4 | 0.9 | 2 | 4.5 | 11 | A | A |
| Example 20 | 37 | 0.8 | 8 | 4 | 0.9 | 2 | 4.5 | 11 | A | A |
| Example 21 | 37 | 0.8 | 8 | 4 | 0.9 | 2 | 4.5 | 11 | B | B |
| Example 22 | 37 | 0.8 | 8 | 4 | 0.9 | 2 | 4.5 | 11 | B | B |
| Example 23 | 37 | 0.8 | 8 | 4 | 0.9 | 2 | 4.5 | 11 | B | B |
| Example 24 | 37 | 0.8 | 8 | 4 | 0.9 | 2 | 4.5 | 11 | B | B |
| Example 25 | 37 | 0.8 | 8 | 4 | 0.9 | 2 | 4.5 | 10 | B | B |
| Comparative | 51 | 1.1 | 5.5 | 4 | 0.9 | 1.375 | 4.5 | 9 | C | C |
| Example 3 | | | | | | | | | | |
| Example 26 | 37 | 2 | 6 | 5 | 2 | 1.2 | 2.5 | 11 | B | B |
| Comparative | 51 | 1.1 | 6 | 3 | 1 | 2.0 | 3 | 9 | C | B |
| Example 4 | | | | | | | | | | |
| Example 27 | 37 | 0.8 | 6 | 4 | 0.8 | 1.5 | 5 | 11 | B | B |
| Comparative | 51 | 1.1 | 4 | 4 | 0.8 | 1 | 5 | 9 | C | B |
| Example 5 | | | | | | | | | | |
| Example 28 | 37 | 0.8 | 8 | 4 | 1 | 2 | 4 | 11 | B | B |
| Comparative | 24 | 1.1 | 6 | 3 | 1 | 2 | 3 | 9 | C | B |
| Example 6 | | | | | | | | | | |
| Example 29 | 25 | 0.8 | 8 | 4 | 0.9 | 2 | 4.5 | 11 | B | A |
| Example 30 | 30 | 0.8 | 8 | 4 | 0.9 | 2 | 4.5 | 11 | B | A |
| Example 31 | 50 | 0.8 | 8 | 4 | 0.9 | 2 | 4.5 | 11 | A | B |
| Example 32 | 35 | 0.8 | 8 | 4 | 0.9 | 2 | 4.5 | 11 | A | A |
| Example 33 | 4 | 0.8 | 8 | 4 | 0.9 | 2 | 4.5 | 11 | A | A |
| Comparative | 5 | 1.1 | 5.5 | 4 | 0.9 | 1.375 | 4.5 | 9 | C | A |
| Example 7 | | | | | | | | | | |
| Comparative | 20 | 1.1 | 5.5 | 4 | 0.9 | 1.375 | 4.5 | 9 | C | B |
| Example 8 | | | | | | | | | | |
| Comparative | 17 | 1.1 | 5.5 | 4 | 0.9 | 1.375 | 4.5 | 9 | C | C |
| Example 9 | | | | | | | | | | |

The descriptions in the tables will be described.

The item “Presence ratio in regions within 400 nm” means the percentage of the release agent present in regions whose distances from the surfaces of the toner particles are 400 nm or less with respect to the total amount of the release agent when a cross section of the toner particles is observed.

The item “Presence ratio in regions 2 μm or more (%, with respect to binder resin)” means the percentage of the release agent present in regions whose distances from the surfaces of the toner particles are 2 μm or more with respect to the total amount of the binder resin when a cross section of the toner particles is observed.

The item “Lub/Res)×100” means the ratio of the percentage of the release agent on the surfaces of the toner particles as measured by X-ray photoelectron spectroscopy to the percentage of the binder resin on the surfaces of the toner particles as measured by X-ray photoelectron spectroscopy.

The item “Temperature of dispersion (R) when release agent is added” is the temperature (° C.) of the dispersion (R) when the release agent particle dispersion is added in the first aggregated particle forming step or the second aggregated particle forming step.

As can be seen from the above results, with the toners for electrostatic image development in the Examples, the difference in gloss that occurs when images are formed continuously can be reduced.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A toner for electrostatic image development, comprising:
toner particles containing a binder resin, a dye, and a release agent,
wherein, when a cross section of the toner particles is observed, the percentage of the release agent present in regions whose distances from the surfaces of the toner particles are 400 nm or less is from 25% to 50% inclusive with respect to the total amount of the release agent.

2. The toner for electrostatic image development according to claim 1, wherein, when the cross section of the toner particles is observed, the percentage of the release agent present in the regions whose distances from the surfaces of the toner particles are 400 nm or less is from 30% to 45% inclusive with respect to the total amount of the release agent.

3. The toner for electrostatic image development according to claim 2, wherein, when the cross section of the toner particles is observed, the percentage of the release agent present in the regions whose distances from the surfaces of the toner particles are 400 nm or less is from 35% to 40% inclusive with respect to the total amount of the release agent.

4. The toner for electrostatic image development according to claim 1, wherein the content of the release agent with respect to the mass of the toner particles is from 5% by mass to 10% by mass inclusive.

5. The toner for electrostatic image development according to claim 1, wherein the dye is a basic dye.

6. The toner for electrostatic image development according to claim 5, wherein the basic dye is at least one selected from rhodamine-based dyes having a cationic group and azo-based dyes having a cationic group.

7. The toner for electrostatic image development according to claim 1, wherein the binder resin includes an amorphous resin having an acid value of from 9 mgKOH/g to 15 mgKOH/g inclusive.

8. The toner for electrostatic image development according to claim 1, wherein the binder resin includes a urea-modified polyester resin as an amorphous resin.

9. The toner for electrostatic image development according to claim 1, wherein the release agent is at least one selected from paraffin waxes, polyethylene waxes, microcrystalline waxes, and ester-based waxes.

10. A toner for electrostatic image development, comprising:
toner particles containing a binder resin, a dye, and a release agent,
wherein the ratio of the percentage of the release agent on the surfaces of the toner particles as measured by X-ray photoelectron spectroscopy to the percentage of the binder resin on the surfaces of the toner particles as measured by X-ray photoelectron spectroscopy is 10% or more.

11. A toner for electrostatic image development, comprising:
toner particles containing a binder resin, a dye, and a release agent,
wherein, when a cross section of the toner particles is observed, formula 1: 1.5≤W1/W2 and formula 2: 4≤W2/W3 are satisfied, where W1 is the area of the release agent present in regions whose distances from the surfaces of the toner particles are less than 1 μm, w2 is the area of the release agent present in regions whose distances from the surfaces of the toner particles are 1 μm or more and less than 2 μm, and W3 is the area of the release agent present in regions whose distances from the surfaces of the toner particles are 2 μm or more.
